(19) United States
(12) Patent Application Publication
(10) Pub. No.: US 2012/0259983 A1
(43) Pub. Date: Oct. 11, 2012

(54) DISTRIBUTED PROCESSING MANAGEMENT SERVER, DISTRIBUTED SYSTEM, DISTRIBUTED PROCESSING MANAGEMENT PROGRAM AND DISTRIBUTED PROCESSING MANAGEMENT METHOD

(75) Inventor: Shinji Nakadai, Tokyo (JP)

(73) Assignee: NEC CORPORATION, Minato-ku, Tokyo (JP)

(21) Appl. No.: 13/516,648

(22) PCT Filed: Dec. 15, 2010
(86) PCT No.: PCT/JP2010/073061

§ 371 Date: Jun. 15, 2012

(30) Foreign Application Priority Data
Dec. 18, 2009 (JP) 2009-287080

(51) Int. Cl. G06F 15/173

(52) U.S. Cl. 709/226

(57) ABSTRACT

Systems that include devices that store data and devices that can process data could not determine which devices are to transfer data. The disclosed management device comprises a load computation unit and a processing allocation unit. The load computation unit acquires processing devices (j) and, for each of complete data sets i, data device list i for data devices storing the complete data set. Based on the communications load between each acquired processing device and data device, the load computation unit computes c′ij, which includes the communications load involved in data processing device j receiving one data unit of complete data set i from the data devices in data device list i. the processing allocation unit determines an amount fij of complete data set i for data processing device j to receive so as minimize a sum includes fij·c′ij.

### TECHNICAL FIELD

The present invention relates to a distributed processing management server, a distributed system, a distributed processing management program and a distributed processing management method.

### BACKGROUND ART

Non-patent documents 1 to 3 disclose a distributed system which determines to which of the plurality of calculation servers data stored in a plurality of computers is to be transmitted and processed. This system successively determines a usable calculation server which is the nearest from a server which stores individual data, and determines the whole communications.

Patent document 1 discloses a system which makes a relay server move so that data transfer time may become smallest at the time of transferring data stored in one computer to one client 300.

Patent document 2 discloses a system which performs division transfer at the time of file transfer from a file transfer source machine to a file transfer destination machine according to line speed and load status of each transfer route.

Patent document 3 discloses a system in which one job distribution device divides data required for executing a job, and transmits to a plurality of calculation servers arranged in each of a plurality of network segments. This system reduces the network load by accumulating data once for each of the network segment units.

Patent document 4 discloses technology which creates a communication graph showing distance between processors, and creates a communication schedule based on this graph.

[Non-patent document 1] Jeffrey Dean and Sanjay Ghemawat, “MapReduce: Simplified Data Processing on Large Clusters”, Proceedings of the sixth Symposium on Operating System Design and Implementation (OSDI'04), Dec. 6, 2004

[Non-patent document 2] Sanjay Ghemawat, Howard Gobioff, and Shun-Tak Leung, “The Google File System”, Proceedings of the nineteenth ACM symposium on Operating systems principles (SOSP'03), Oct. 19, 2003

[Non-patent document 3] Nishida Keisuke, the technology supporting Google, p. 74, p136-p163, Apr. 25, 2008
[Patent document 1] Japanese Patent Application Publication No. 1996-202726
[Patent document 2] Japanese Patent Application Publication No. 2001-320439
[Patent document 3] Japanese Patent Application Publication No. 2006-236123
[Patent document 4] Japanese Patent Application Publication No. 1997-330304

### DISCLOSURE OF THE INVENTION

### Problem to be Solved by the Invention

Technologies of the above-mentioned patent documents cannot determine appropriate data transfer from which server to which server in the system that forms distributed arrangement of a plurality of servers which store data and a plurality of servers which can process the data.

The technologies of patent documents 1 and 2 only optimize one to one data transfer. The technologies of non-patent documents 1 to 3 also only successively optimize one to one data transfer (refer to FIG. 2A). The technology of patent document 3 only discloses one to N data transfer. The technology of patent document 4 does not reduce a data transfer cost.

An object of the present invention is to provide a distributed processing management server, a distributed system, a distributed processing management program and distributed processing management method which solve the above-mentioned problem.

### Means for Solving a Problem

An exemplary embodiment of this invension is a distributed processing management device comprising:

a load computation means which acquires identifiers j for a plurality of processing devices and, for each of one or more (m-set) complete data sets i, identifiers (a data device list i) for one or more (n-unit, m or n is a plural) data devices that are storing data belonging to the complete data set, and, on the basis of a communications load (an inter-device communications load) per unit data volume between each acquired processing device and each data device, computes a complete data unit quantity processing load (c′ij) including the communications load (a complete data unit quantity acquisition load cij) of which each processing device receives the unit data volume of each complete data set from the data device in the data device list of each complete data set; and a processing allocation means which determines a nonnegative amount (the communication volume fij) of which each processing device receives each complete data set so that a prescribed sum of value including the product (a complete data processing load fijc'ij) of each complete data unit quantity processing load and each communication volume may become minimum, and outputs decision information.

An exemplary embodiment of this invension is a computer readable recording medium having embodied thereon a distributed processing management program, which when executed by a computer, causes the computer to process the following processing of:

load computation processing for acquiring identifiers j for a plurality of processing devices and, for each of one or more (m-set) complete data sets i, identifiers (a data device list i) for one or more (n-unit, m or n is a plural) data devices that are storing data belonging to the complete data set, and, on the basis of a communications load (an inter-device communications load) per unit data volume between each acquired processing device and each data device, computing a complete data unit quantity processing load (c′ij) including the communications load (a complete data unit quantity acquisition load cij) of which each processing device receives the unit data volume of each complete data set from the data device in the data device list of each complete data set; and

processing allocation processing for determining a nonnegative amount (the communication volume fij) of which each processing device receives each complete data set so that a prescribed sum of value including the product (a complete data processing load fijc'ij) of each complete data unit quantity processing load and each communication volume may become minimum, and outputing decision information.

### Effect of the Invention

The present invention can realize data transmission and reception among appropriate servers as the whole when a plurality of data storage servers and a plurality of processable servers are given.

An exemplary embodiment of this invension is a distributed processing management method comprising:

acquiring identifiers j for a plurality of processing devices and, for each of one or more (m-set) complete data sets i, identifiers (a data device list i) for one or more (n-unit, m or n is a plural) data devices that are storing data belonging to the complete data set, and, on the basis of a communications load (an inter-device communications load) per unit data volume between each acquired processing device and each data device, computing a complete data unit quantity processing load (c′ij) including the communications load (a complete data unit quantity acquisition load cij) of which each processing device receives the unit data volume of each complete data set from the data device in the data device list of each complete data set; and

determining a nonnegative amount (the communication volume fij) of which each processing device receives each complete data set so that a prescribed sum of value including the product (a complete data processing load fijc'ij) of each complete data unit quantity processing load and each communication volume may become minimum, and outputing decision information.

### BRIEF DESCRIPTION OF THE DRAWINGS

FIG. 1A is a configuration diagram of a distributed system 340 according to the first exemplary embodiment.

FIG. 1B indicates a configuration example of the distributed system 340.

FIG. 2A indicates an inefficient communication example in the distributed system 340.

FIG. 2B indicates an efficient communication example in the distributed system 340.

FIG. 3 indicates the composition of a client 300, a distributed processing management server 310, a processing server 320 and a data server 330.

FIG. 4 exemplifies a user program inputted to a client 300.

FIG. 5A indicates an example of a data set and a data element.

FIG. 5B indicates distributed forms of the data set.

FIG. 6A exemplifies information stored in a data location storing unit 3120.

FIG. 6B exemplifies information stored in a server status storing unit 3110.

FIG. 6C exemplifies composition of decision information.

FIG. 6D exemplifies general composition of a communications load matrix C.

FIG. 6E exemplifies the communications load matrix C in the first exemplary embodiment.

FIG. 7A indicates combination of the data volume stored in a data server 330 and division processing which this exemplary embodiment describes (1/2).

FIG. 7B indicates combination of the data volume stored in a data server 330 and division processing which this exemplary embodiment describes (2/2).

FIG. 8 is an overall operation flowchart of the distributed system 340.

FIG. 9 is an operation flowchart of the client 300 in Step 801.

FIG. 10 is an operation flowchart of the distributed processing management server 310 in Step 802.

FIG. 11 is an operation flowchart of the distributed processing management server 310 in Step 803.

FIG. 12 is an operation flowchart of the distributed processing management server 310 in Step 805.

FIG. 13 exemplifies a user program inputted to a client 300 of the third exemplary embodiment.

FIG. 14 exemplifies another user program inputted to a client 300 of the third exemplary embodiment.

FIG. 15 is an operation flowchart of the distributed processing management server 310 of the third exemplary embodiment in Steps 802 and of 803.

FIG. 16 exemplifies a set of data server list at the time of associated designation which associates in accordance with appearance order of the data element.

FIG. 17 is an operation flowchart of the distributed processing management server 310 of the fourth exemplary embodiment in Step 803.

FIG. 18A indicates a configuration of the distributed system 340 used by a specific example of the first exemplary embodiment or the like.

FIG. 18B indicates information stored in a server status storing unit 3110 provided in the distributed processing management server 310.

FIG. 18C indicates information stored in a data location storing unit 3120 provided in the distributed processing management server 310.

FIG. 18D indicates a user program inputted to a client 300.

FIG. 18E indicates a communications load matrix C.

FIG. 18F indicates a flow rate matrix F.

FIG. 18G indicates data transmission and reception determined based on the flow rate matrix F of FIG. 18F.

FIG. 19A indicates a user program inputted in a specific example of the second exemplary embodiment.

FIG. 19B indicates information stored in a data location storing unit 3120 in the first example of the second exemplary embodiment.

FIG. 19C indicates a communications load matrix C.

FIG. 19D indicates a flow rate matrix F.

FIG. 19E indicates data transmission and reception determined based on the flow rate matrix F of FIG. 19D.

FIG. 19F is an operation flowchart example of flow rate matrix F creation by the processing allocation unit 314.

FIG. 19G indicates matrix conversion process in objective function minimization.

FIG. 19H indicates information stored in a data location storing unit 3120 in the second example of the second exemplary embodiment.

FIG. 19I indicates a communications load matrix C.

FIG. 19J indicates a flow rate matrix F.

FIG. 19K indicates data transmission and reception determined based on the flow rate matrix F of FIG. 19J.

FIG. 20A indicates information stored in a data location storing unit 3120 of the first example of the third exemplary embodiment.

FIG. 20B indicates a configuration of the distributed system 340 of the first example.

FIG. 20C indicates a communications load matrix C.

FIG. 20D indicates a flow rate matrix F.

FIG. 20E indicates information stored in a data location storing unit 3120 of the second example of the third exemplary embodiment.

FIG. 20F indicates a configuration of the distributed system 340 of the second example.

FIG. 20G is an operation flowchart of the load computation unit 313 for aquiring a data server list.

FIG. 20H indicates a work table for the first data set (MyDataSet1) used in the processing of FIG. 20G.

FIG. 20I indicates a work table for the second data set (MyDataSet2) used in the processing of FIG. 20G.

FIG. 20J indicates an output list created in the processing of FIG. 20G.

FIG. 20K indicates a communications load matrix C.

FIG. 20L indicates a flow rate matrix F.

FIG. 21A indicates a configuration of the distributed system 340 of a specific example of the fourth exemplary embodiment.

FIG. 21B indicates information stored in a data location storing unit 3120.

FIG. 21C indicates a restoration example of encoded partial data set.

FIG. 21D indicates a communications load matrix C.

FIG. 21E indicates a flow rate matrix F.

FIG. 22A indicates the system configuration of a specific example of the first example of the fifth exemplary embodiment.

FIG. 22B indicates a communications load matrix C.

FIG. 22C indicates a flow rate matrix F.

FIG. 22D indicates inter-server band which the inter-server load acquisition unit 318 or the like has measured.

FIG. 22E indicates a communications load matrix C.

FIG. 22F indicates a flow rate matrix F.

FIG. 23 indicates a distributed system 340 including a plurality of output servers 350 in addition to a distributed processing management server 310, a plurality of data servers 330 and a plurality of processing servers 320.

FIG. 24 indicates an exemplary embodiment of a basic structure.

### DESCRIPTION OF THE CODES

300 client
301 structure program storing unit
302 processing program storing unit
303 processing request unit
304 processing requirements storing unit
310 distributed processing management server
313 load computation unit
314 processing allocation unit
315 memory
316 work area
317 distributed processing management program
318 inter-server load acquisition unit
320 processing server
321 P data storing unit
322 P server management unit
323 program library
330 data server
331 D data storing unit
332 D server management unit
340 distributed system
350 output server
3110 server status storing unit
3111 P server ID
3112 load information
3113 configuration information
3120 data location storing unit
3121 data set name
3122 distributed form
3123 partial data description
3124 local file name
3125 D server ID
3126 data volume
3127 partial data name

### EXEMPLARY EMBODIMENT

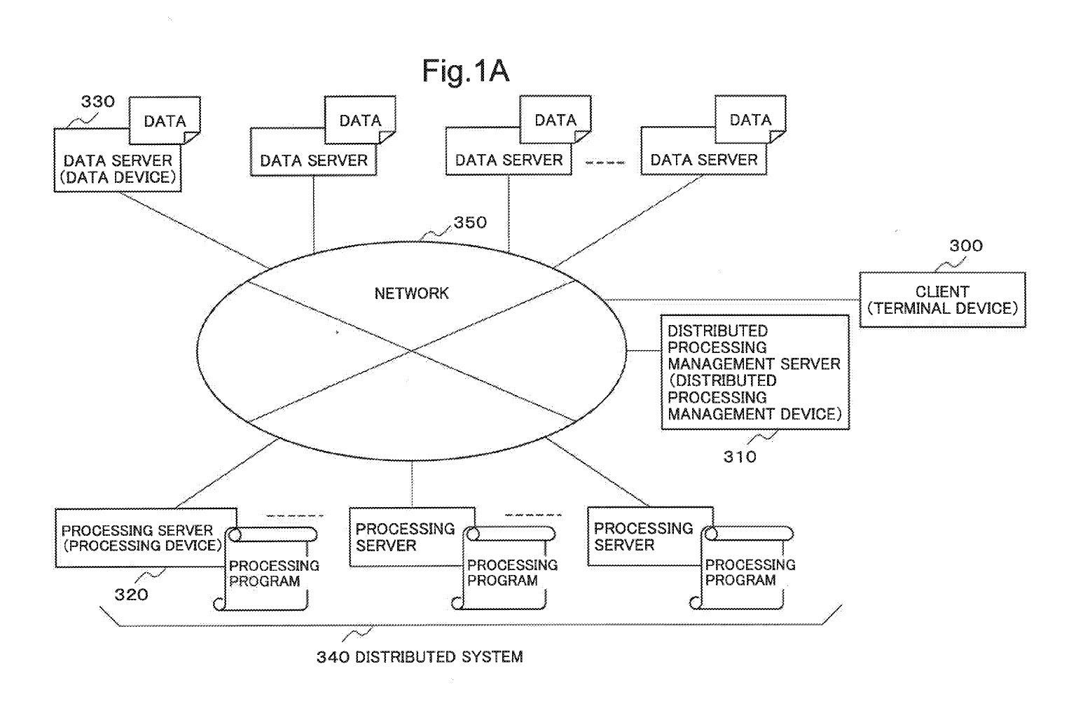

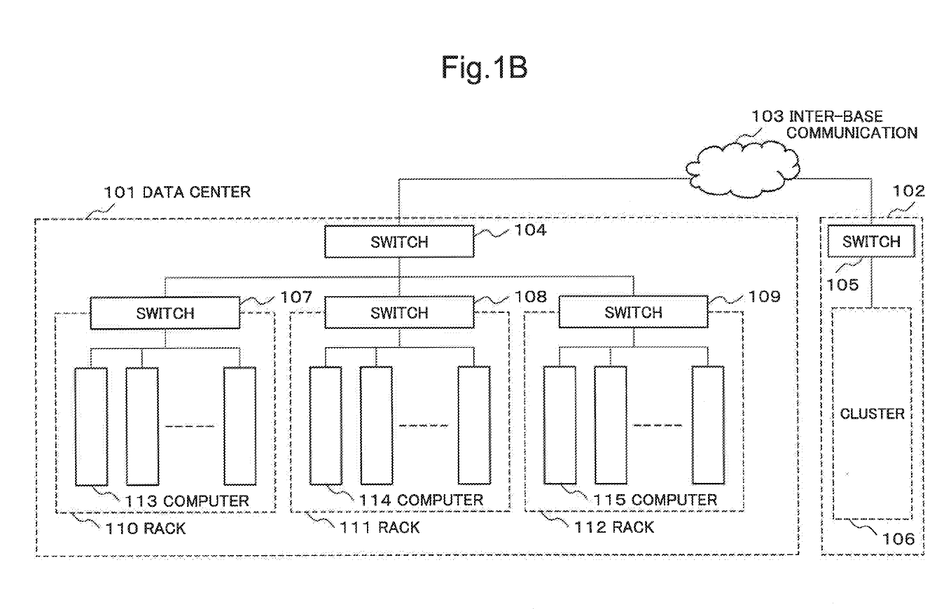

FIG. 1A is a configuration diagram of a distributed system 340 according to a first exemplary embodiment. The distributed system 340 includes a distributed processing management server 310, a plurality of processing servers 320 and a plurality of data servers 330 connected by a network 350. The distributed system 340 may include a client 300 and other servers which are not illustrated.

The distributed processing management server 310 is also called a distributed processing management device, the processing server 320 is also called a processing device, the data server 330 is also called a data device and the client 300 is also called a terminal device.

Each of the data servers 330 stores object data to be processed. Each of the processing servers 320 has processing capability that receives data from a data server 330, executes a processing program and processes the data.

The client 300 requests the distributed processing management server 310 to start data processing. The distributed processing management server 310 determines which processing server 320 should receive how mach amount of data from which data server 330 and outputs the decision information. Each of the data servers 330 and the processing servers 320 performs data transmission and reception based on the decision information. The processing server 320 processes the received data.

Here, the distributed processing management server 310, the processing server 320, the data server 330 and the client 300 may be dedicated devices or may be general-purpose computers. Also, one device or a computer, which hereafter may be reffered as a computer or the like, may possess a plurality of functions of one or more of the distributed processing management server 310, the processing server 320, the data server 330 and the client 300. Hereafter, one or more of the distributed processing management server 310, processing server 320, the data server 330 and the client 300 may be rffered as a distributed processing management server 310 and the like. In many cases, one computer or the like functions as both of the processing server 320 and the data server 330.

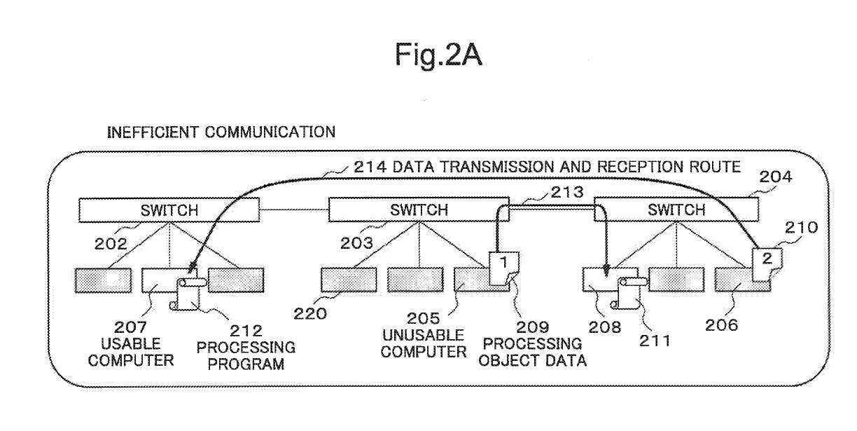

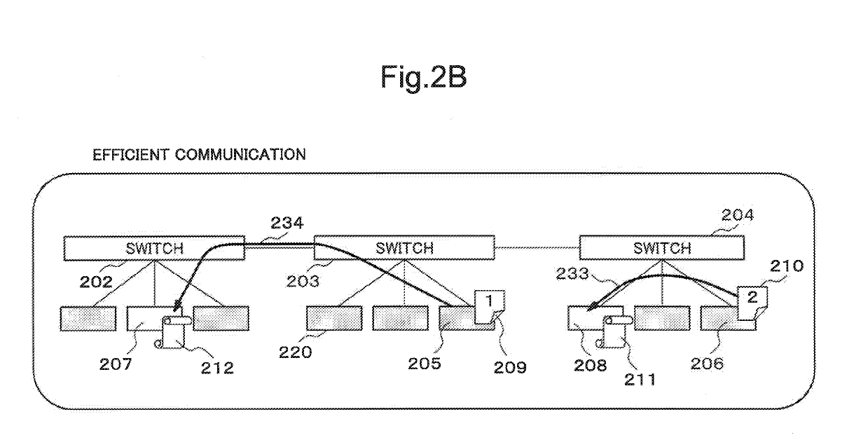

FIG. 1B, FIG. 2A and FIG. 2B indicate configuration examples of the distributed system 340. In these figures, the processing server 320 and the data server 330 are described as computers. The network 350 is described as data transmitting and receiving paths via switches. The distributed processing management server 310 is not clearly indicated.

In FIG. 1B, the distributed system 340, for example, includes computers 113-115 and switches 104 and 107-109 that connect those computers. The computers and the switchs are installed in racks 110-112, and further those are accommodated in data centers 101-102, and the data centers are connected by the inter-base communication 103.

FIG. 1B exemplifies the distributed system 340 in which switches and computers are connected in the star-type. FIG. 2A and FIG. 2B exemplifies the distributed system 340 which is composed of switches forming cascade connection.

FIG. 2A and FIG. 2B, each indicates an example of data transmission and reception between a data server 330 and a processing server 320. In both figures, the computers 205 and 206 function as a data server 330, and the computers 207 and 208 function as a processing server 320. Further, in these figures, for example, the computer 220 is functioning as a distributed processing management server 310.

In FIG. 2A and FIG. 2B, among computers connected by the switches 202-204, other than 207 and 208 cannot be used due to other processing under execution. Among those unusable computers, each of the computers 205 and 206 stores data 209 and 210 of processing objects. The usable computers 207 and 208 are provided with processing programs 211 and 212.

In FIG. 2A, data 209 of processing object is transmitted through a data transmitting and receiving path 213 and processed by the usable computer 208. The processing object data 210 is transmitted through a data transmitting and receiving path 214 and processed by the usable computer 207.

On the other hand, in FIG. 2B, the processing object data 209 is transmitted through a data transmitting and receiving path 234 and processed by the usable computer 207. The processing object data 210 is transmitted through a data transmitting and receiving path 233 and processed by the usable computer 208.

In data transmission and reception in FIG. 2A, there are 3 times of inter-switch communication, but in contrast, there is once in data transmission and reception in FIG. 2B. The data transmission and reception in FIG. 2B involves a low communications load and is efficient compared with the data transmission and reception in FIG. 2A.

A system, which determines a computer for performing data transmission and reception of each processing object data successively based on a constitutive distance, may sometimes perform inefficient transmission and reception as shown in FIG. 2A. For example, a syatem, which focuses on the processing object data 209 first and detects 207 and 208 as usable computers, then, selects the computer 208 which is located constitutively near the processing server 320, eventually performs the transmission and reception shown in FIG. 2A.

The distributed system 340 according to this exemplary embodiment increases a possibility of performing the efficient data transmission and reception shown in FIG. 2B in circumstances exemplified by FIG. 2A and FIG. 2B.

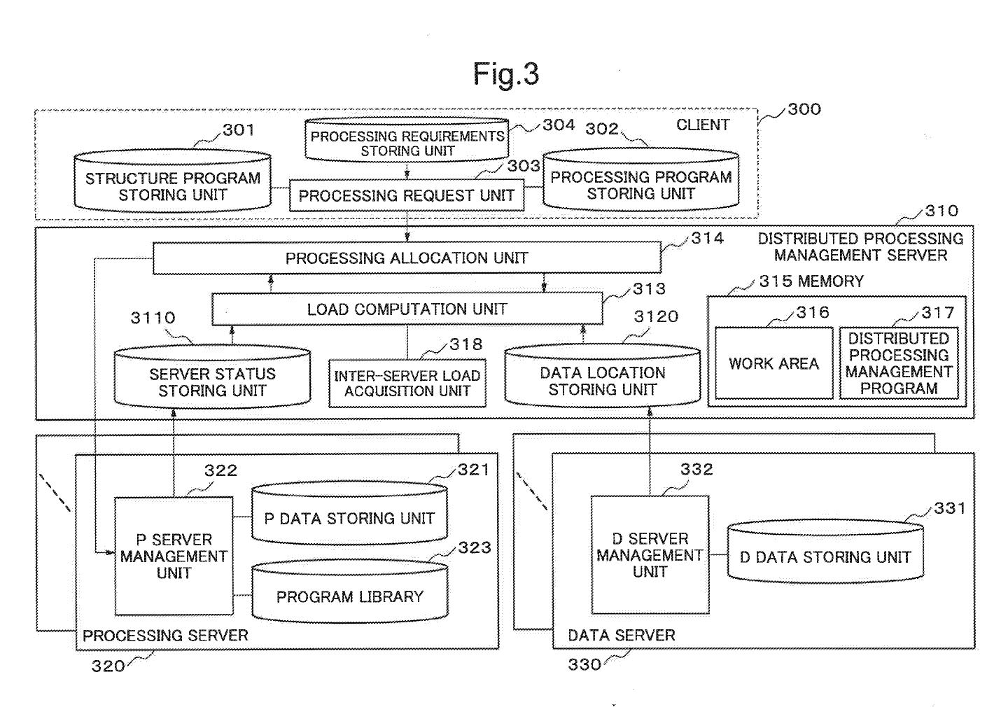

FIG. 3 indicates a configuration of the client 300, the distributed processing management server 310, the processing server 320 and the data server 330. When one computer or the like has a plurality of functions provided in the distributed processing management server 310 or the like, the configutation of this computer or the like, for example, will be one in which a plurality of compositions of the distributed processing management server 310 or the like are added each other. In this case, the computer or the like does not need to have a common component redundantly, and may share it.

For example, when the distributed processing management server 310 also operates as a processing server 320, the configuration of this server, for example, will be one in which each composition of the distributed processing management server 310 and the processing server 320 are added each other. A P data storing unit 321 and a D data storing unit 331 may be a common storing unit.

The processing server 320 includes a P data storing unit 321, a P server management unit 322 and a program library 323. The P data storing unit 321 stores data identified uniquely in the distributed system 340. The logical configuration of this data will be mentioned later. The P server management unit 322 executes processing requested by a client 300 for the data stored in the P data storing unit 321 as an object. The P server management unit 322 executes a processing program stored in the program library 323 and executes this processing.

The data of processing object is received from the data server 330 designated by the distributed management server 310 and stored in the P data storing unit 321. When the processing server 320 is a computer or the like which is the same as the data server 330, the data of processing object may have been stored in the P data storing unit 321 in advance before the client 300 requests processing.

The processing program is received from a client 300 at the time of a processing request by the client 300, and is stored in the program library 323. The processing program may be received from the data server 330 or the distributed processing management server 310, and it may also have been stored in the program library 323 in advance before the client 300 requests processing.

The data server 330 includes a D data storing unit 331 and a D server management unit 332. The D data storing unit 331 stores data identified uniquely in the distributed system 340. The data may be data which has been outputted or is being outputted from the data server, may be data which has been received from the other server or the like, and may also be data which has been read from a storage medium or the like.

The D server management unit 332 transmits the data stored in the D data storing unit 331 to the processing server 320 designated by the distributed processing management server 310. A transmission request of data is received from the processing server 320 or the distributed processing management server 310.

The client 300 includes a structure program storing unit 301, a processing program storing unit 302, a processing request unit 303 and a processing requirements storing unit 304.

The structure program storing unit 301 stores the information about how to process data and structure of data obtained by processing. A user of the client 300 designates the information.

The structure program storing unit 301 stores structural information which indicates that identical processing is to be performed to designated sets of data respectively, information about a storage location of the data set which is obtained by identical processing having been performed, or structural information which indicates the obtained data set is to be received by other processing in the succeeding stage. The structural information, for example, specifies the structure such as execution of designated processing to a designated input data set in a preceding stage, and in the succeeding stage, concentration of the output data of processing in the preceding stage.

The processing program storing unit 302 stores a processing program which describes what kind of processing to perform to a designated data set and data elements included in that. The processing program stored here is distributed, for example, to processing servers 320, and this processing is performed.

The processing requirements storing unit 304 stores requirements about the amount of processing servers 320 to be used when this processing is carried out in the distributed system 340. The amount of processing servers 320 may be designated by the number of rocessing servers, or may be designated by the value of processing capability based on the CPU (Central Processing Unit) clock speed. Further, the processing requirements storing unit 304 may also store requirements about classification of the processing server 320. Classification of the processing server 320 may be classification about OS (Operating System), CPU, a memory and peripheral devices, and it may be a quantitative index about those such as the memory size.

The information stored in the structure program storing unit 301, the processing program storing unit 302 and the processing requirements storing unit 304 is given to a client 300 as a user program or system parameters.

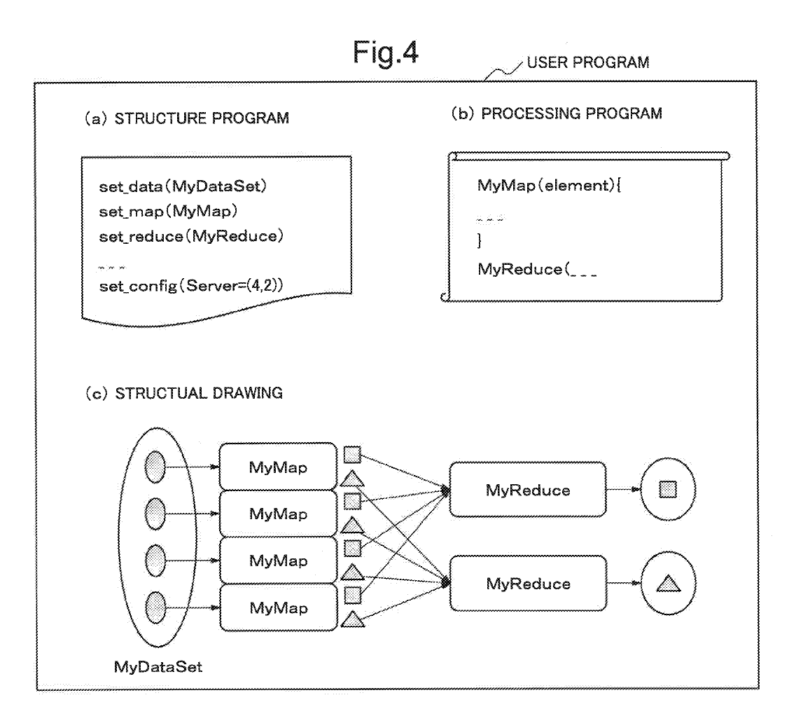

FIG. 4 exemplifies a user program inputted to a client 300. The user program includes (a) a structure program and (b) a processing program. The structure program and the processing program can be described by the user directly, and also can be created by a compiler or the like as a result of compiling an application program described by the user. The structure program describes a processing object data name, a processing program name and processing requirements. For example, the processing object data name is described as an argument of set_data phrase. For example, the processing object program name is described as an argument of set_map phrase or set_reduce phrase. For example, the processing requirements are described as an argument of set_config phrase.

The structure program in FIG. 4 is describing, for example, to apply the processing program of MyMap to the data set of MyDataSet and to apply the processing program of MyReduce to the output of MyMap. Further, the structure program is describing that MyMap should be processed by four units and MyReduce should be processed by two units of processing servers 320 in parallel. In FIG. 4, (c) structural drawing is a figure which expresses the structure of a user program.

This structural drawing is added for the purpose of understanding the specification easily, and is not included in the user program. This is also applied to the user program written in the subsequent figures.

The processing program describes data processing procedures. For example, the processing program in FIG. 4 specifically describes processing procedures of MyMap and MyReduce by a programming language.

The distributed processing management server 310 includes a data location storing unit 3120, a server status storing unit 3110, a load computation unit 313, an inter-server load acquisition unit 318, a processing allocation unit 314 and a memory 315.

In the data location storing unit 3120, for each name of data set which is identified uniquely in the distributed system 340, one or more identifiers of data servers 330, which store data belonging to the data set, are stored.

The data set is a set of one or more data elements. The data set may be defined as a set of identifiers of data elements, a set of identifiers of data element groups and a set of data which satisfies common conditions, or it may be defined as the union of sets or the product set of these sets.

The data element becomes a unit of input or output of one processing program. As shown in the structure program of FIG. 4, in the structure program, the data set may be explicitly designated by the distinguished name or may be designated by a relation with other processing such as an output result of a designated processing program.

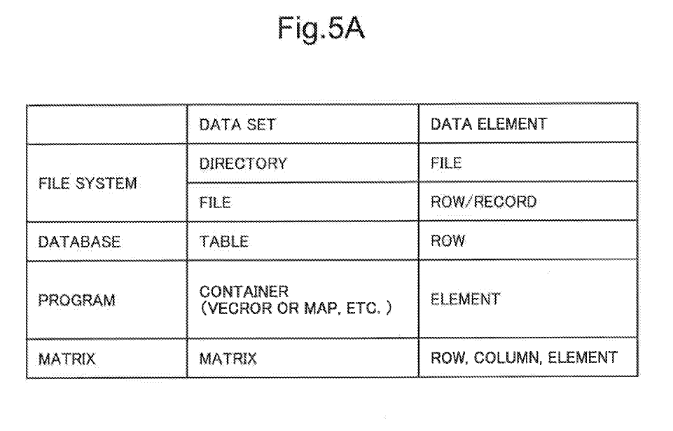

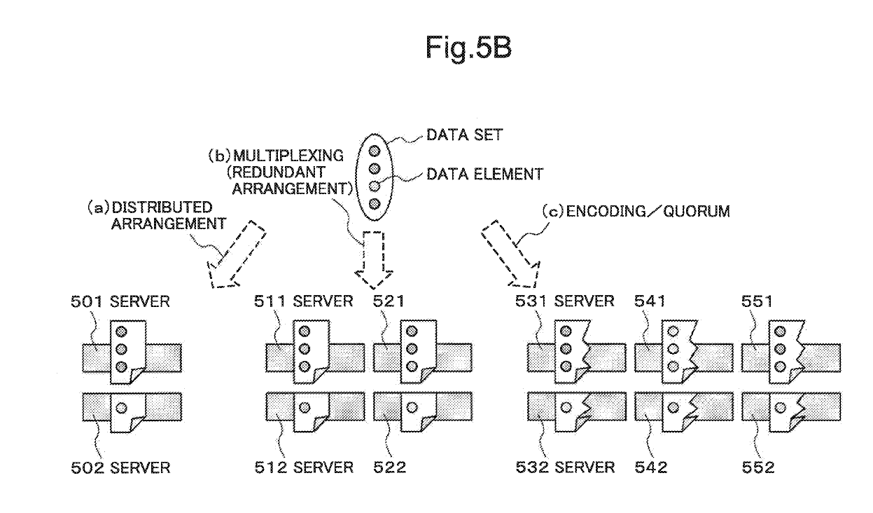

The data set and the data element typically correspond to a file and a record in the file, however, it is not limited to this correspondence. FIG. 5A indicates an example of the data set and the data element. This figure exemplifies correspondence in a distributed file system.

When the processing program receives each distributed file as an argument, a data element is a distributed file. In this case, a data set is a set of distributed files and for example, is specified by a distributed file directory-name, enumeration of a plurality of distributed file names or common condition to the file name. The data set may be enumeration of a plurality of distributed file directory-names.

When the processing program receives each row or each record as an argument, a data element becomes a row or a record in a distributed file. In this case, for example, a data set is a distributed file.

A data set may be a table in a relational database, and the data element may be each row of the table. A data set may be a container of Map and Vector or the like of a program such as C++ and Java (registered trademark), and a data element may be an element of a container. Further, a data set may be a matrix, and a data element may be a row, a column or a matrix element.

This relation between a data set and an element is specified by the contents of a processing program. This relation may be written in a structure program.

Whichevere the case of the data set and the data element, the data set of processing object is determined by designation of the data set or a plurality of the data elements, and mapping information of this data set to the data servers 330 which store this data set is stored in the data location storing unit 3120.

Each data set may be divided into a plurality of subsets (partial data set) and distributed to a plurality of data servers 330 (FIG. 5B (a)). In FIG. 5B, servers 501-552 are data servers 330.

A certain distributed data may be located in each of two or more data servers 330 by being multiplexed for redundancy (FIG. 5B (b)). The processing server 320 may input a data element from any one of the distributed data being multiplexed in order to process the multiplexed data element.

A certain distributed data may be located in each of n (three or more) units of data servers 330 by being encoded (FIG. 5B (c)). Here, encoding is performed using Erasure code or Quorum method or the like known to the public. The processing server 320 may input K units of data elements, where K is the minimum acquisition number and is smaller than n, of the distributed data being encoded in order to process the data elements.

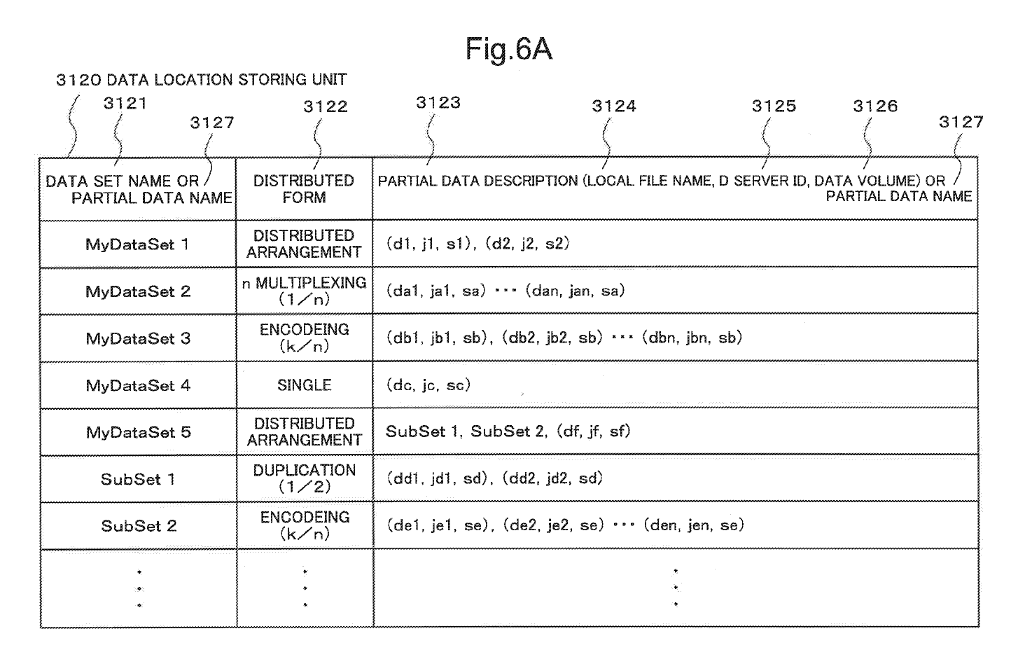

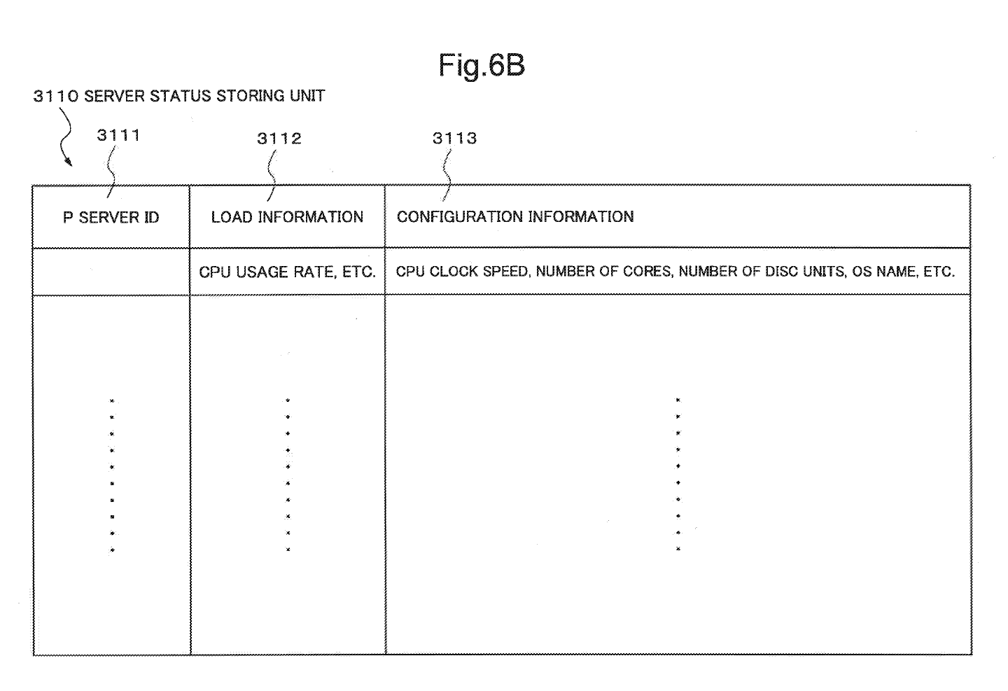

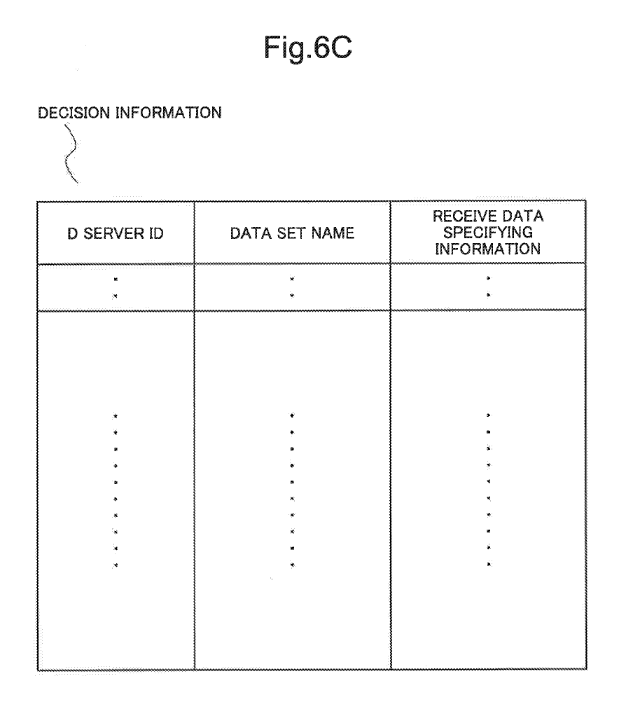

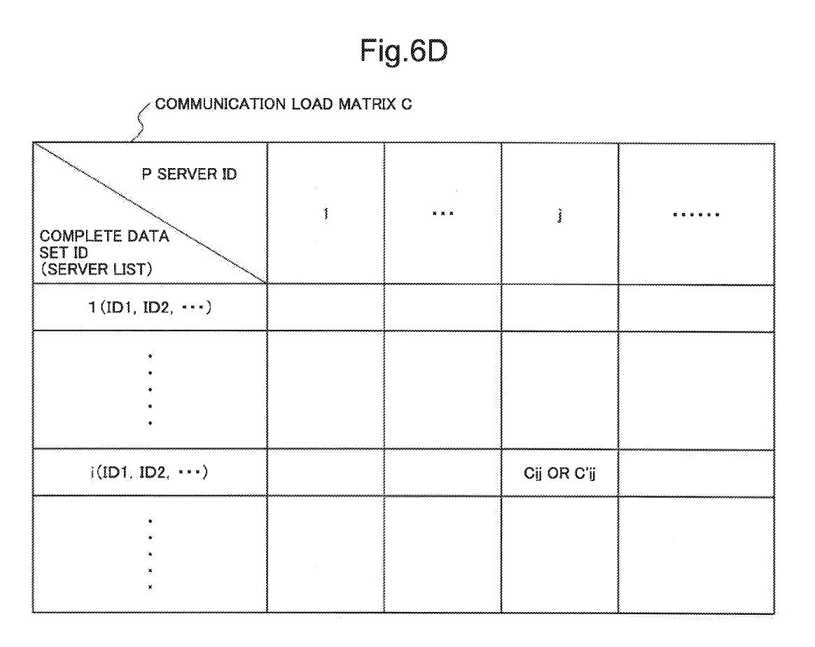

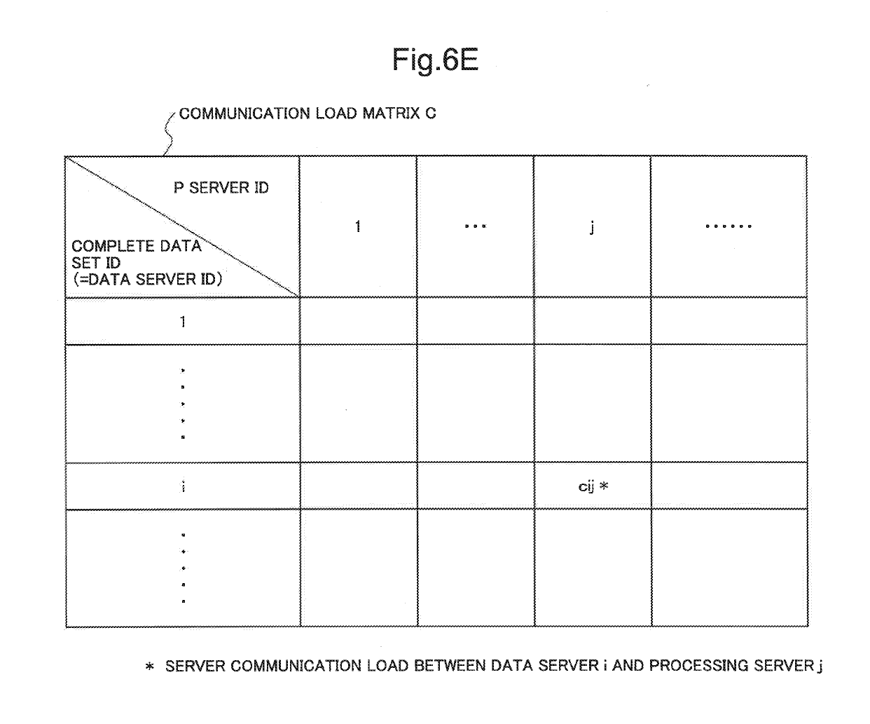

FIG. 6A exemplifies information stored in the data location storing unit 3120. The data location storing unit 3120 stores a plurality of rows for each data set name 3121 or partial data name 3127. When a data set (MyDataSet1, for example) is being divided into subsets and distributed to data servers, a row of this data set includes the description about this fact in distributed form 3122, and the partial data description 3123 for each partial data set belonging to this data set.

The partial data description 3123 includes local file name 3124, D server ID 3125 and data volume 3126. The D server ID3125 is an identifier of the data server 330 which stores this partial data set. This identifier may be a unique name in the distributed system 340, or may be an IP address. The local file name 3124 is a unique file name in the data server 330 in which this partial data set is stored. The data volume 3126 is the number of gigabytes (GB) or the like that indicates the size of this partial data set.

When some or all of partial data sets of a data set (such as MyDataSet5) is multiplexed or encoded, description of distributed arrangement is stored in the distributed form 3122, and name of this partial data set (such as SubSet1, or SubSet2) is stored in each partial data name 3127 of the row corresponding to this data set. At this time, the data location storing unit 3120 stores a row corresponding to each of this partial data name 3127 (for example, the sixth or seventh row of FIG. 6A).

When a partial data set (for example, SubSet1) is multiplexed (for example, duplicated), the row of this partial data set includes description of this fact (distributed form 3122) and a partial data description 3123 for each multiplexed data set of the partial data set. This partial data description 3123 stores an identifier (D server ID 3125) of the data server 330 which stores multiplexed data set of the partial data set, a unique file name (local file name 3124) in the data server 330 and the size of the data set (data volume 3126).

When a partial data set (for example, SubSet2) is encoded, the row of this partial data set includes description of this fact (distributed form 3122) and a partial data description 3123 for each of n encoded data chunks of the partial data set. Each of the partial data descriptions 3123 stores an identifier (D server ID 3125) of the data server 330 which stores an encoded data chunk of the partial data set, a unique file name (local file name 3124) and the size (data volume 3126) of the data chunk. The distributed form 3122 also includes description of the fact that the partial data set can be restored when arbitrary k encoded data chunks are acquired among n encoded data chunks.

Data set (for example, MyDataSet2) may be multiplexed without being divided into partial data sets. In this case, the partial data description 3123 in the row of this data set exists corresponding to each of the multiplexed data sets of the data set. The partial data description 3123 stores an identifier (D server ID 3125) of the data server 330 which stores the multiplexed data set, a unique file name (local file name 3124) in the data server 330 and the size (data volume 3126) of the data.

Data set (for example, MyDataSet3) may be encoded without being divided into partial data sets. Data set (for example, MyDataSet4) does not need to be divided into partial data sets, to be made redundant nor to be encoded.

Further, when the distributed form of data set handled by the distributed system 340 is single, the data location storing unit 3120 may not include the description of distributed form 3122. For the sake of simplicity, the explanation of the exemplary embodiment hereafter will be given by supposing that the distributed form of data set is essentially any one of the forms mentioned above. In order to cope with combination of a plurality of the forms, the distributed processing management server 310 or the like changes the processing, which will be explained hereafter, based on the description of distributed form 3122.

The data of processing object has been stored in the D data storing unit 331 prior to data processing request by a client 300. Data of processing object may be given to a data server 330 by a client 300 or other server or the like when the client 300 requests data processing.

Further, although FIG. 3 shows a case where this distributed processing management server 310 exists in specific one computer or the like, the server status storing unit 3110 or the data location storing unit 3120 may be distributed in devices using a technology of distributed hash table.

FIG. 6B exemplifies information stored in the server status storing unit 3110. The server status storing unit 3110 stores P server ID 3111, load information 3112 and configuration information 3113 for each processing server 320 being operated in the distributed system 340. The P server ID 3111 is an identifier of the processing server 320. The load information 3112 includes information relating to a processing load of the processing server 320, for example, a CPU usage rate, an input/output busy rate. The configuration information 3113 includes the status information on configuration and setting of the processing server 320, for example, OS and the hardware specification.

Information stored in the server status storing unit 3110 and the data location storing unit 3120 may be updated by a state notification from the processing server 320 or the data server 330, or may be updated by response information obtained as a response to an inquiry of the distributed processing management server 310.

The processing allocation unit 314 accepts a data processing request from the processing request unit 303 of a client 300. The processing allocation unit 314 selects processing servers 320 to be used for this processing, determines which processing server 320 should acquire, to process, a data set from which data server 330, and outputs the decision information.

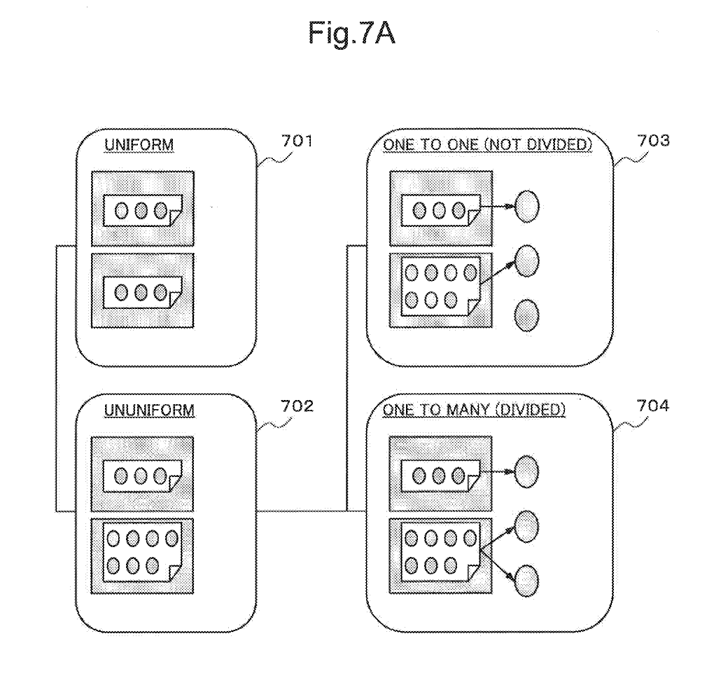

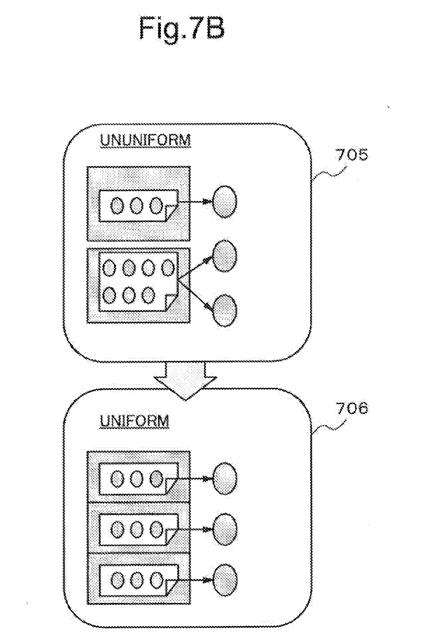

FIG. 6C exemplifies composition of the decision information. The decision information exemplified in FIG. 6C is transmitted by the processing allocation unit 314 to each processing server 320. The decision information specifies, for the processing server 320 having received, which data set should be received from which data server 330. In a case where a plurality of processing servers 320 receive data of one data server 330 (it will be described later in 704 of FIG. 7A), the decision information also includes receive data specifying information. The receive data specifying information is information for specifying which data in the data set is to be received. For example, it is an identifier set of data records or section designations (starting position and transfer volume) in a local file of the data server 330. The receive data specifying information specifies the data transfer volume indirectly. Each processing server 320, which has received the decision information, requests the data server 330 specified by the receive data specifying information to transmit data.

Also, the decision information may be transmitted by the processing allocation unit 314 to each data server 330. In this case, the decision information specifies which data of which data set to be transmitted to which processing server 320.

A data processing request which the processing allocation unit 314 accepts from a client 300 includes data set names 3121 of the data sets to be processed, processing program names representing processing contents, a structure program which describes a relation between a processing program and the data set and processing programs. When the distributed processing management server 310 or the processing server 320 is already equipped with processing programs, the data processing request does not have to include the processing programs. Further, when the data set names 3121 of the data sets to be processed, the processing program names representing processing contents and the relation between the processing programs and the data sets are fixed, the data processing request does not have to include the structure program.

Also, the data processing request may include a constraint and a quantity as processing requirements for the processing server 320 which is used for this processing. The constraint is OS or the hardware specification or the like of the processing server 320 to be selected. The quantity is the number of servers to be used, the number of CPU cores or a quantity similar to that.

When the data processing request is accepted, the processing allocation unit 314 activates the load computation unit 313. The load computation unit 313 refers to the data location storing unit 3120, and acquires a list of data servers 330 which store data belonging to a complete data set, for example, a set of the lists of identifiers of data servers 330 (data server lists).

The complete data set is a set of data elements needed by a processing server 320 for executing processing. The complete data set is determined based on description of a structure program (set_data phrase) or the like. For example, the structure program shown in FIG. 4(a) indicates that a complete data set of MyMap processing is a set of data elements of MyDataSet.

When a structure program designates one data set as a processing object, and this data set is arranged in a distributed manner, and each distributed partial data set is neither being multiplexed nor encoded (for example, MyDataSet1 of FIG. 6A), each partial data set or a part of each partial data set becomes a complete data set. At this time, each data server list includes an identifier of one data server 330 (D server ID 3125) which stores each partial data set, and it becomes a list of one element. For example, the server list of the first complete data set of MyDataSet1, that is, the partial data set (d1,j1,s1), is the list of one element j1. The server list of the second complete data set of MyDataSet1, that is, the partial data (d2,j2,s2), is the list of one element j2. Accordingly, the load computation unit 313 acquires j1 and j2 as a set of data server lists.

Further, the processing which targets a data set of the other distributed form 3122 will be explained in the followed exemplary embodiment.

Next, the load computation unit 313 selects a usable processing server 320 for data processing with reference to the server status storing unit 3110, and acquires its identifier set. Here, the load computation unit 313 may judge whether the processing server 320 is usable for data processing with reference to load information 3112. For example, when it is being use by other computation processes (a CPU usage rate is predetermined threshold value or more), the load computation unit 313 may judge that the processing server 320 cannot be used.

Further, the load computation unit 313 may judge, with refernce to configuration information 3113, that the processing server 320 which does not satisfy processing requirements included in a data processing request which has been received from a client 300 cannot be used. For example, when the data processing request designates specific type of CPUs and OS, and configuration information 3113 of a certain processing server 320 includes other type of CPUs and OS, the load computation unit 313 may judge that the processing server 320 cannot be used.

Further, the server status storing unit 3110 may include a priority that is not illustrated in the configuration information 3113. The priority stored in the server status storing unit 3110 is, for example, a priority of the processing other than the data processing of the processing server 320 requested from a client 300, which is referred as “other processing” hereafter. The priority is stored during execution of the other processing.

Even if a processing server 320 is executing the other processing and the CPU usage rate is high, the load computation unit 313 may acquire the processing server 320 as usable, when this priority is lower than the priority included in a data processing request. This same unit transmits a process execution cancel request to the processing server 320 acquired in this way.

The priority included in the data processing request is acquired from a program or the like inputted by a client 300. For example, a structure program includes a priority designation in Set_config phrase.

The load computation unit 313 creates a communications load matrix C, in which a complete data unit acquisition load cij is used as an element, in a work area 316 or the like of the memory 315 based on the load relating to communication between each processing server 320 and the data server 330 acquired as mentioned above (inter-server communications load).

The inter-server communications load is information which expresses the unfavorable degree, in other words degree of avoidance, for communication between two servers as a value per unit communication data volume.

The inter-server communications load is, for example, communication time necessary per one unit communication volume, or the amount of buffer, which is the retention data volume, on the communication route. The communication time may be time required for one packet to come and go, or time required for transmitting a fixed amount of data, for example, a reciprocal number of bandwidth of the link layer, or a reciprocal number of the available bandwidth at the time). The load may be an actual measured value or an estimated value.

For example, the inter-server load acquisition unit 318 computes the statistic values, such as an averages, of actual mesurement of communication between two servers or between racks accommodating the servers. The actual measurament are stored in a memory storage or the like not illustrated in the distributed processing management server 310. This same unit stores the computed values in a work area 316 or the like as the inter-server communications load. The load computation unit 313 obtains the inter-server communications load with reference to the work area 316 or the like.

The inter-server load acquisition unit 318 may compute a predicted value of the inter-server communications load using the time series prediction technique based on the above-mentioned actual mesurement of communication. Moreover, this same unit may allocate a finit degree coordinate to each server, find a delay value supposed by Euclidean distance between the coordinates and make it the inter-server communications load. This same unit may find a delay value supposed by the match length from the head of IP address assigned to each server, and make it the inter-server communications load.

Moreover, the inter-server communications load may be the amount of payment or the like occurred per one unit communication volume to be paied to a communication carrier. In this case or the like, an inter-server communication matrix between each processing server 320 and the data server 330 is given to the load computation unit 313 as a system parameter or the like from an administrator or the like of the distributed system 340. In such case, the inter-server load acquisition unit 318 becomes unnecessary.

The communications load matrix C is a matrix which arranges the processing servers 320 acquired by the above in a row and the data server lists in a column, and uses the complete data unit acquisition load cij as an element. The complete data unit acquisition load cij is a communications load for a processing server j to obtain the unit communication volume of complete data set i.

Further, as will be indicated in the exemplary embodiment below, the communications load matrix C may use the value referred as “complete data unit quantity processing load c′ij” in which a processing capability index value of processing server j is added to cij as an element. FIG. 6D exemplifies a communications load matrix C.

In case of the data set which is an object of this exemplary embodiment, because each partial data set is a complete data set as explained above, the complete data unit acquisition load cij becomes a load for receiving the unit communication volume only from the data server i which stores the partial data set i. That is, the complete data unit acquisition load cij becomes the inter-server communications load itself between the data server i and the processing server j. FIG. 6E exemplifies the communications load matrix C in this exemplary embodiment.

The processing allocation unit 314 computes a flow rate matrix F which minimizes an objective function. The flow rate matrix F is a matrix of communication volume (a flow rate) having rows and columns corresponding to the obtained communications load matrix C. The objective function has a communications load matrix C as a fixed number and has a flow rate matrix F as a variable.

The objective function is a summation (Sum) fuction when the object is minimization of the total amount of communications load given to the distributed system 340, and is a maximum (Max) function when the object is to minimize the longest execution time of data processing.

The objective function which the processing allocation unit 314 minimizes and the constraint equations used at the time of the minimization depend on how data is distributed to each data server 330 and the method of processing the data in the destribution system 340. The objective function and the constraint equations are given by a system manager or the like to the distributed processing management server 310 as the system parameter or the like according to the distributed system 340.

Data volume of each data server 330 is measured by the binary amount such as megabyte (MB) or the quantity of blocks divided into fixed quantity in advance. As shown in FIG. 7A, the amount of data which each data server 330 stores may be identical for all data servers 330 or different for each data server 330. Also, it may be possible or impossible for the data stored in one data server 330 to be divided and processed by different processing servers 320. The load computation unit 313 uses the objective function and the constraint equations depending on the case shown in FIG. 7A.

First, there are a uniform case (701) and an ununiform case (702) for the distributed amount of object data set in the data server 330. In the ununiform case (702), there is a case (704) that the data server holding the data can be associated with a plurality of processing servers 320, and there is a case (703) that it can be associated with only one processing server 320. The case of being associated with a plurality of processing servers 320 means, for example, a case in which the data is divided and a plurality of processing servers 320 respectively process its part. Dividing in the uniform case is processed, for example, by included in the ununiform case (704). Further more, the distributed processing management server 310 handles, as shown in FIG. 7B, also the ununiform case (705) by including in the uniform case (706) regarding essentially the same data server 330 as a plurality of different servers on processing.

The present exemplary embodiment indicates the objective function and the constraint equations about these three models. In the exemplary embodiments after the second exemplary embodiment, one of above three models will be used, however, other model may be employed depending on the intended distributed system 340.

Symbols used in the equations are as follows. VD is a set of data servers 330, and VN is a set of usable processing servers 320. cij is a complete data unit acquisition load, and in this exemplary embodiment, it is the inter-server communications load between element i of VD and element j of VN, and is an element of a communications load matrix C. fij is an element of a flow rate matrix F and is communication volume between element i of VD and element j of VN. di is the volume of data that is stored in the server i belonging to VD. E takes the addition about a designated set, and Max takes the maximum value about a designated set. min represents minimization, and s.t. represents a constraint.

The minimization formula of the objective function for a model of 701 of FIG. 7A is the objective function of formula 1 or formula 2, and the constraint equations are formula 3 and formula 4.

min. ΣiεVD,jεVN cijfij (1)

min. MaxjεVNΣiεVD cijfij (2)

s.t. fijε{0,1}(∀iεVD,∀jεVN) (3)

s.t. ΣjεVN fij=1(∀iεVD) (4)

That is, in formula 1, the processing allocation unit 314 computes the communication volumes fij between servers i and j which minimize the addition, for all combinations between i and j, of the product of the inter-server communications load between the data server i and the processing server j and the communication volume between them. This product cijfij is referred as complete data processing load. In formula 2, this same unit computes the communication volumes between servers which minimize the maximum value of the numbers derived by adding this product for all the data servers 330 with respect to each processing server 320. The communication volume takes a value of 0 or 1 depending on performing transmission or not, and, with respect to any data server 330, the summation of the communication volume for the whole processing servers 320 is 1.

In a model of 703 of FIG. 7A, the processing allocation unit 314 uses the objective function of formula 5 or formula 6, and uses the constraint equations of formula 3 and formula 4. Formula 5 and formula 6 are same as formula 1 and formula 2 when di=1 (∀iεVD).

min. ΣiεVD,jεVN dicijfij (5)

min. MaxjεVNΣiεVD dicijfij (6)

That is, the processing allocation unit 314 multiplies the communications load from the data server i in formula 1 and formula 2 by the data volume di in data server i.

Next, in a model of 704 of FIG. 7A, the processing allocation unit 314 uses the objective function of formula 1 or formula 2, and uses the constraint equations of formula 7 and formula 8.

s.t. fij≧0(∀iεVD,∀jεVN) (7)

s.t. ΣjεVN fij=di(∀iεVD) (8)

The processing allocation unit 314 computes flow rates, which was treated in formula 3 whether transmitted from data server i or not (0 or 1), as a continuous values under the constraint that the summation of communication volumes from data server i agrees with the data volume in this server i.

Minimization of the objective function can be realized using linear programming and non-linear programming, or Hungarian method in bipartite graph matching, negative closed path division in the minimum cost flow problem and flow augmenting method and preflow-push method in the maximum cost flow problem. The processing allocation unit 314 is realized so that it may carries out any of the above-mentioned or other solution method.

When a flow rate matrix F is determined, the processing allocation unit 314 selects processing servers 320 to be used for data processing, which are rocessing servers 320 of which communication volume fij is not 0 and creates the decision information as illustrated in FIG. 6C based on the flow rate matrix F.

Next, the processing allocation unit 314 transmits the decision information to the P server management unit 322 of the processing server 320 to be used. When the processing server 320 is not equipped with processing programs in advance, the processing allocation unit 314 may simultaneously distribute processing programs received from a client 300, for example.

Each unit of the client 300, the distributed processing management server 310, the processing server 320 and the data server 330 may be realized as a dedicated hardware device, and also may be realized by causing CPU of the client 300 or the like which is also a computer to execute a program. For example, the processing allocation unit 314 and the load computation unit 313 of the distributed management server 310 may be realized as the dedicated hardware devices. These also may be realized by causing CPU of the distributed processing management server 310 which is also a computer to execute a distributed processing management program 317 which is loaded in the memory 315.

Further, designation of the model, the constraint equations and the objective function mentioned above may be written in a structure program or the like, and given to the distributed processing management server 310 from a client 300, or it may also be given to the distributed processing management server 310 as an activation parameter or the like. Further, the distributed processing management server 310 may determine the model with reference to the data location storing unit 3120 or the like.

The distributed processing management server 310 may be installed so that it may correspond to all models, constraint equations and objective functions, or may be installed so that it may correspond to only a specific model or the like.

Next, operation of the distributed system 340 will be explained with reference to flowcharts.

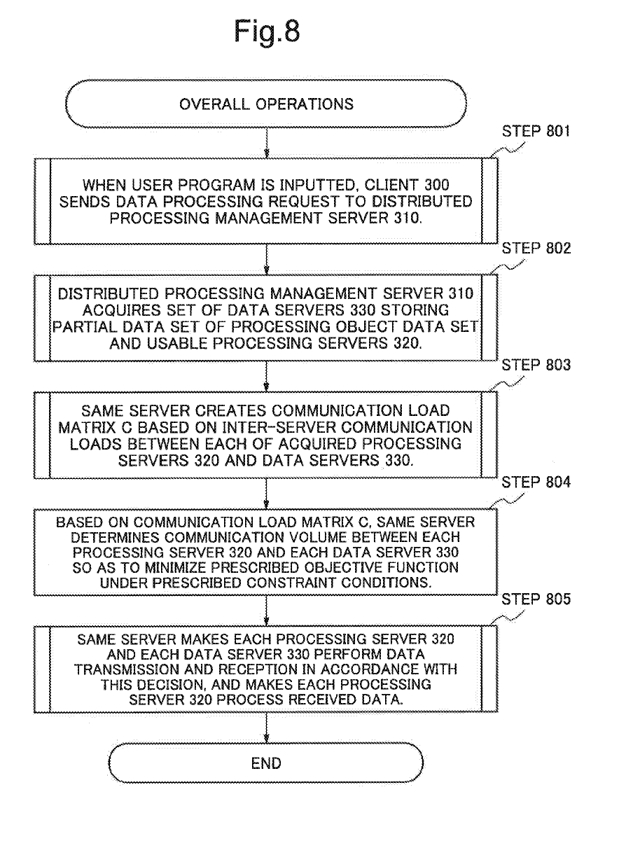

FIG. 8 is an overall operation flowchart of the distributed system 340. When a user program is inputted, the client 300 interprets the program and sends a data processing request to the distributed processing management server 310 (Step 801).

The distributed processing management server 310 acquires a set of data servers 330 storing the partial data set of the processing object data set and usable processing servers 320 (Step 802). The distributed processing management server 310 creates a communications load matrix C based on the inter-server communications load between each of acquired processing servers 320 and data servers 330 (Step 803). The distributed processing management server 310 acquires the communications load matrix C, and determines the communication volume between each processing server 320 and each data server 330 (Step 804), so that the prescribed objective function may be minimized under the prescribed constraint conditions.

The distributed processing management server 310 makes each processing server 320 and each data server 330 perform data transmission and reception in accordance with this decision, and makes each processing server 320 process the received data (Step 805).

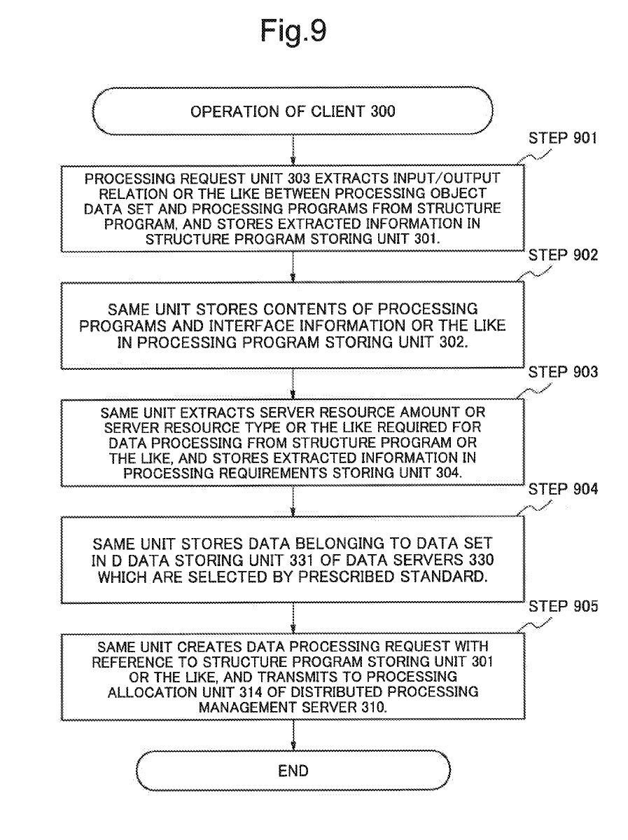

FIG. 9 is an operation flowchart of the client 300 in Step 801. The processing request unit 303 of the Client 300 extracts input/output relations or the like between the processing object data set and the processing programs from the structure program, and stores the extracted information in the structure program storing unit 301 (Step 901). This same unit stores contents of the processing programs and interface information or the like in the processing program storing unit 302 (Step 902). Moreover, this same unit extracts a server resource amount or a server resource type or the like required for the data processing from the structure program or setting information or the like which has been given in advance, and stores the extracted information in the processing requirements storing unit 304 (Step 903).

When the processing object data set is given from the client 300, the processing request unit 303 stores data which belong to the data set in the D data storing unit 331 of the data servers 330 which are selected by the prescribed standard of the communication bandwidth and the storage capacity or the like (Step 904). The processing request unit 303 creates the data processing request with reference to the structure program storing unit 301, the processing program storing unit 302 and the processing requirements storing unit 304, and transmits to the processing allocation unit 314 of the distributed processing management server 310 (Step 905).

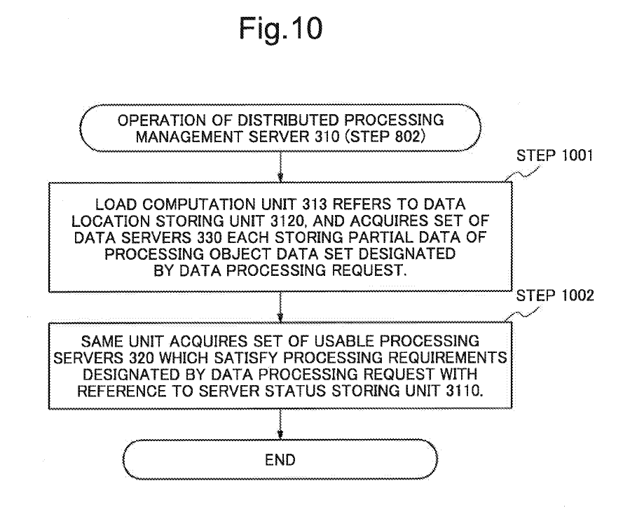

FIG. 10 is an operation flowchart of the distributed processing management server 310 in Step 802. The load computation unit 313 refers to the data location storing unit 3120, and acquires a set of data servers 330 each storing the partial data set of the processing object data set which is designated by the data processing request received from the client 300 (Step 1001). The set of data servers 330 means a set of identifiers or the like of the data servers 330. Next, this same unit acquires a set of usable processing servers 320 which satisfy processing requirements designated by the data processing request with reference to the server status storing unit 3110 (Step 1002).

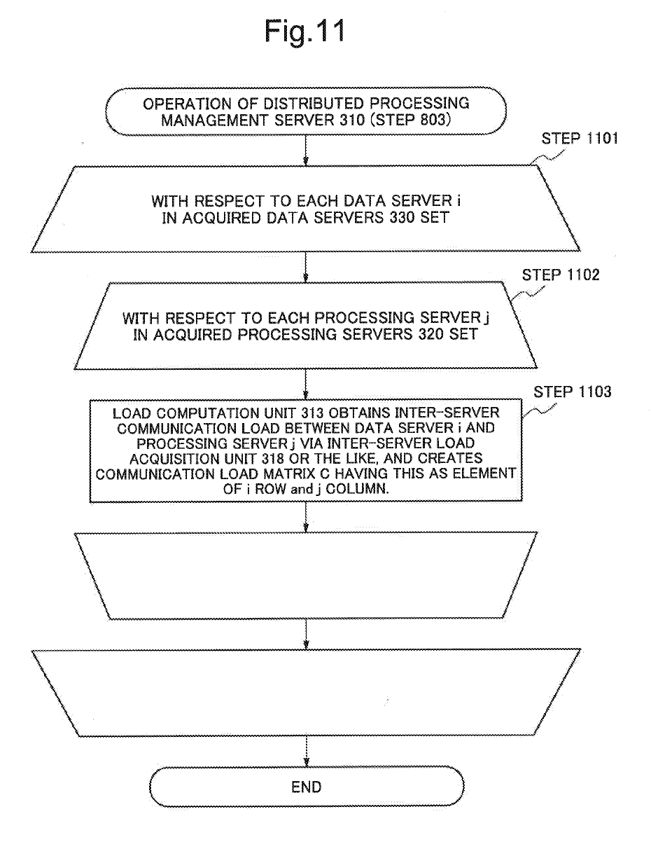

FIG. 11 is an operation flowchart of the distributed processing management server 310 in Step 803. The load computation unit 313 of the distributed processing management server 310 obtains the inter-server communications load between each data server 330 acquired and each processing server 320 acquired, via the inter-server load acquisition unit 318 or the like, and creates a communications load matrix C (Step 1103).

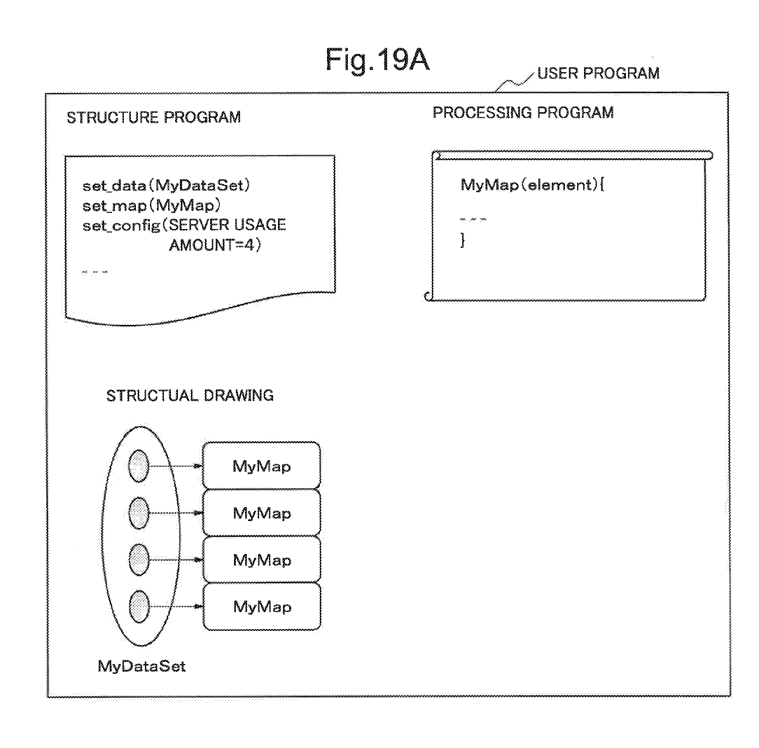

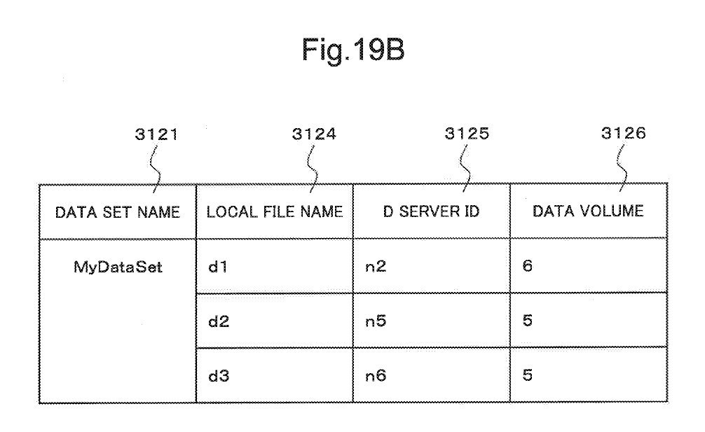

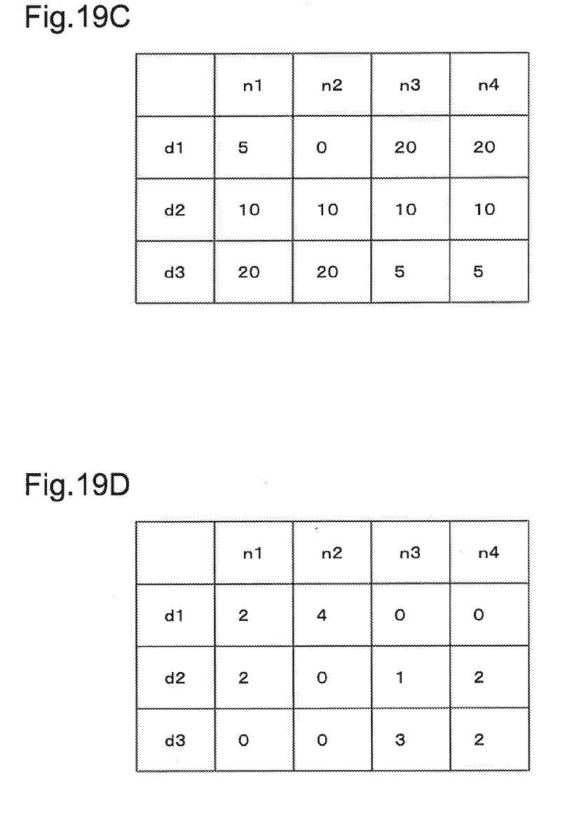

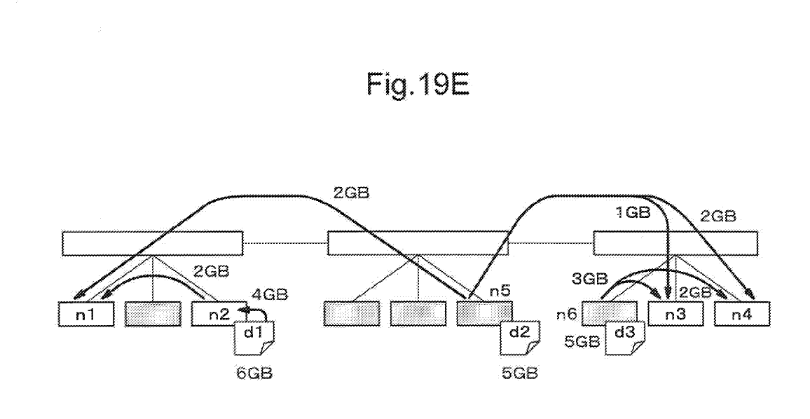

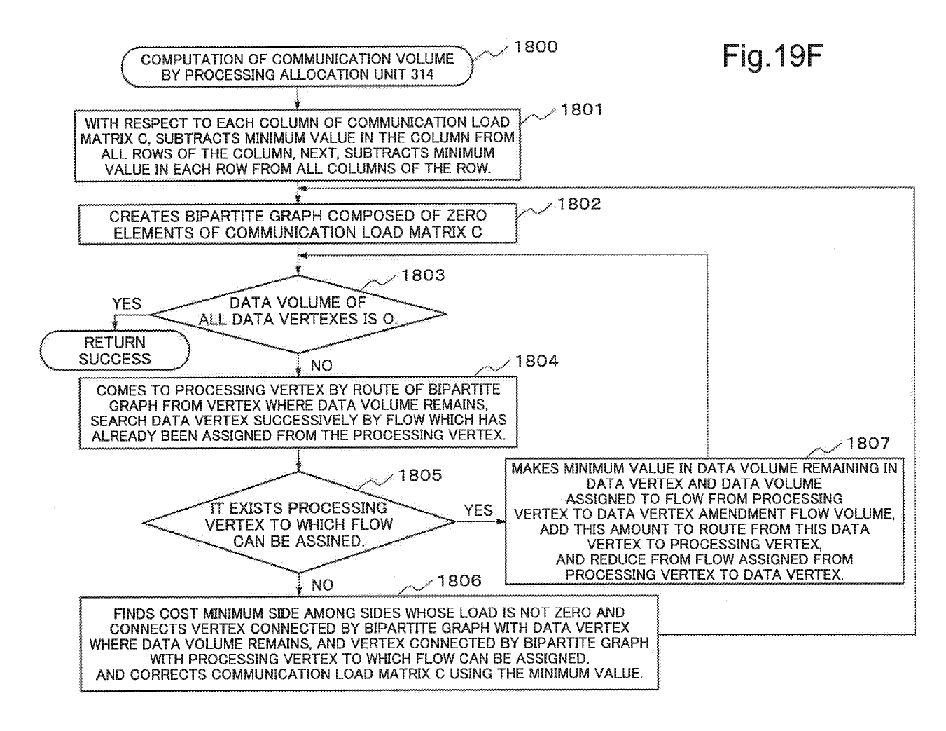

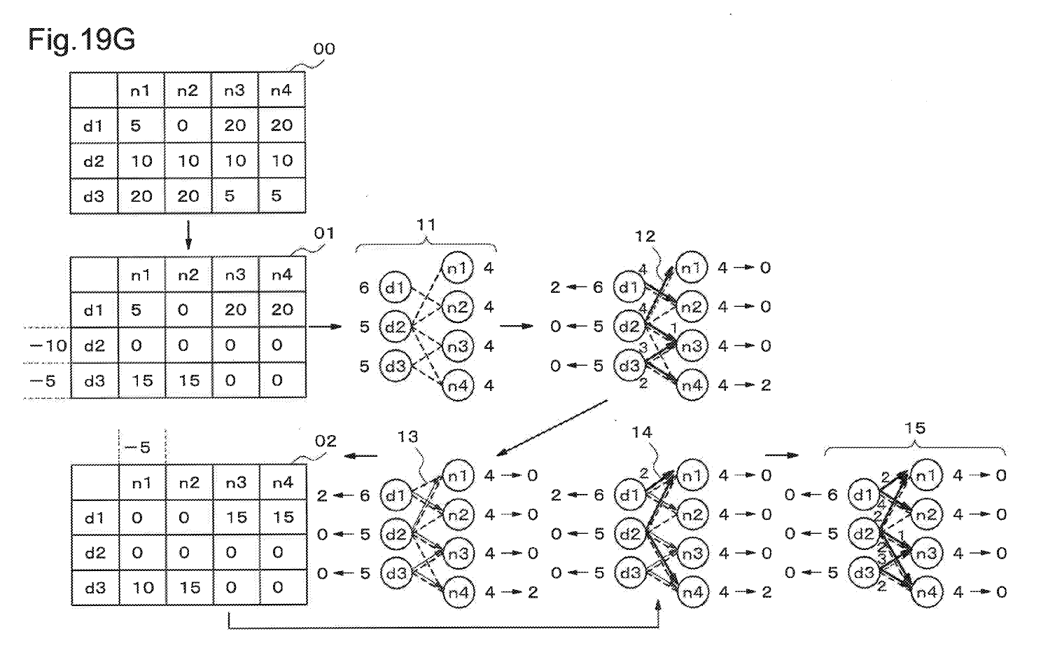

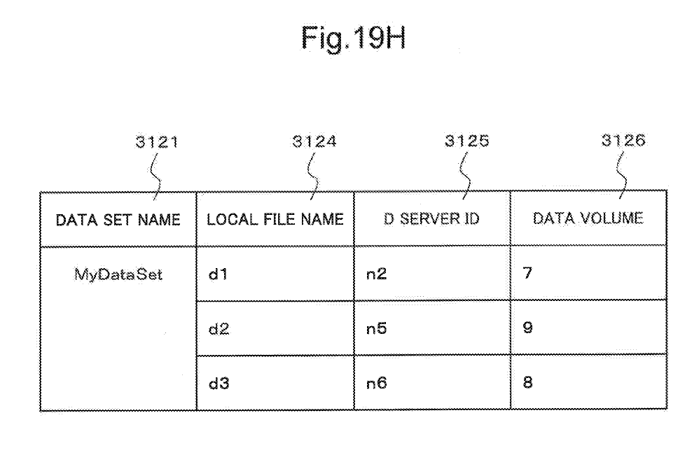

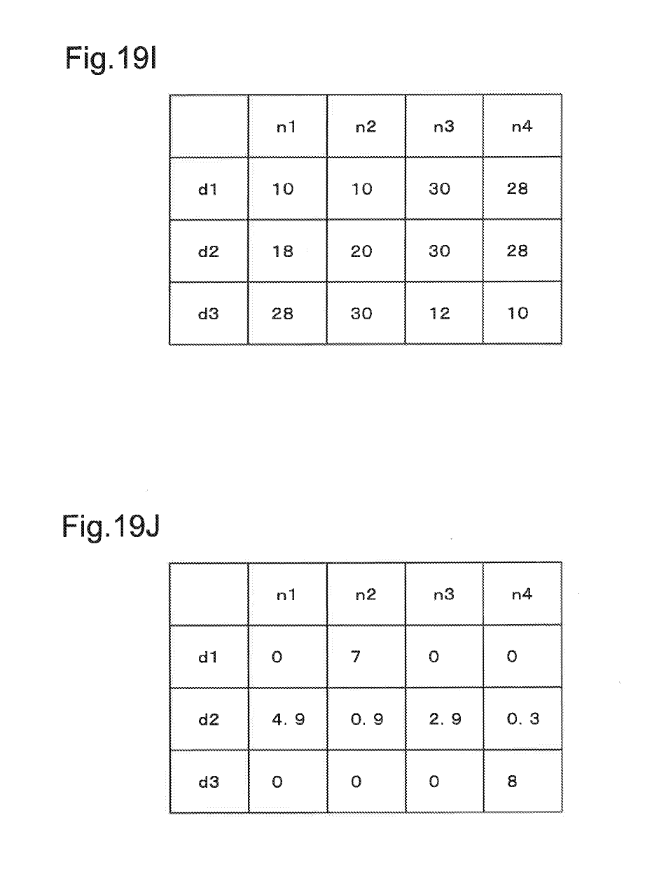

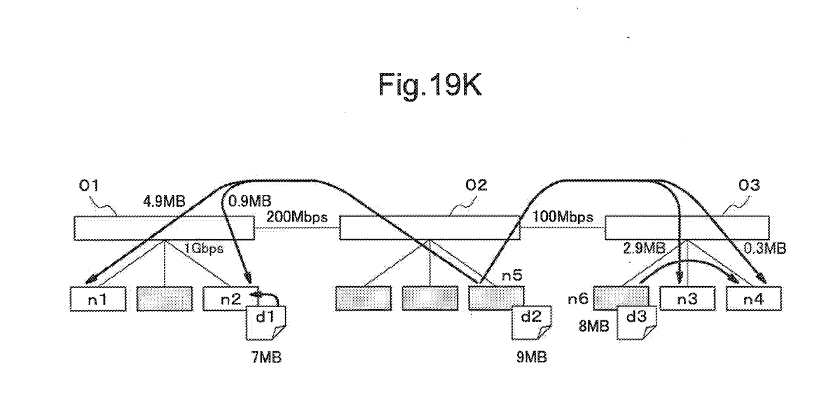

The load computation unit 313 minimizes the objective function based on the communications load matrix C in Step 804. This minimization is performed by using linear programming and Hungarian method or the like. An operation specific example using Hungarian method will be mentioned later with reference to FIG. 19F and FIG. 19G.

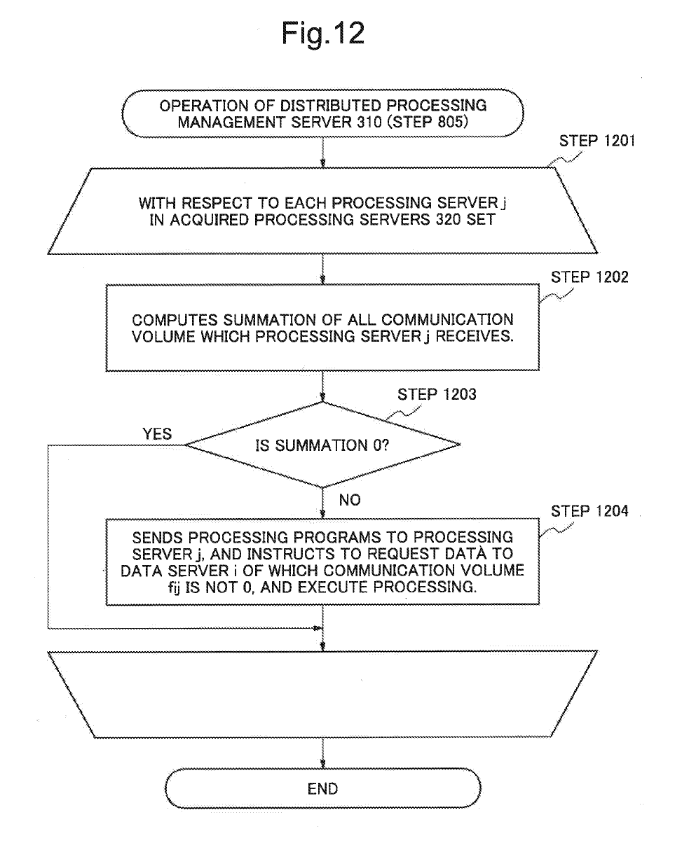

FIG. 12 is an operation flowchart of the distributed processing management server 310 in Step 805. With respect to each processing server j in the acquired processing server 320 set (Step 1201), the processing allocation unit 314 of the distributed processing management server 310 computes the summation of all communication volume which the processing server j receives (Step 1202). When its value is not 0 (NO in Step 1203), the processing allocation unit 314 sends the processing programs to the processing server j.

Further, this same unit instructs the processing server j to send a data acquisition request to the data server i of which the communication volume with own is not 0, and execute data processing” (Step 1204). For example, the processing allocation unit 314 creates the decision information exemplified in FIG. 6C and transmits to the processing server j.

Further, the processing allocation unit 314 of this exempraly embodiment may impose the fixed constraint d′j on the summation of the communication volume about the processing server jas indicated by formula 9A.

s.t. ΣiεVD fij d′j (∀jεVN) (9A)

However, the processing allocation unit 314 sets so that d′j may satisfy formula 9B.

ΣiεVD di≦ΣjεVN d′j (9B)

The first effect of the distributed system 340 of this exemplary embodiment is that it is possible to realize proper data transmission and reception as the whole between the servers when a plurality of data servers 330 and a plurality of processing servers 320 are given.

The reason is because the distributed processing management server 310 determines the data server 330 and the processing server 320 for performing transmission and reception among whole arbitrary combinations of each data server 330 and each processing server 320. In other words, it is because that the distributed processing management server 310 does not determine data transmission and reception between the servers in turn forcusing on the individual data server 330 and the processing server 320.

The data transmission and reception of this distributed system 340 reduces delay of the computation process caused by an insufficient network bandwidth and bad influence to other systems which are sharing the networks.

The second effect of this distributed system 340 is that it is possible to reduce communications load in various aspects such as the communication delay between the servers, the narrow bandwidth, the trouble frequencies and low priority compared with the other systems which share the same communication routes.

The reason is because the distributed processing management server 310 determines proper data transmission and reception between the servers by a method which is not depended on the nature of the load. The load computation unit 313 can input, as the inter-server communications load, the actual measurement value or estimated value of transmission time, a communication bandwidth and the priority or the like.

The third effect of this distributed system 340 is that it is possible to select whether the total volume of the communications load is to be reduced or the communications load of the route with the largest communications load is to be reduced to fit the user's needs. The reason is because the processing allocation unit 314 of the distributed processing management server 310 can minimize an objective function selected from a plurality of formulae such as formula 1, formula 2 or the like.

The fourth effect of this distributed system 340 is that even if other processing is being executed in the processing server 320, it is possible to make the processing server 320 near the data to be processed, stop the other processing and perform the processing, when the priority of the requested data processing is high. As a result, the distributed system 340 can realize proper data transmission and reception between the servers as the whole for the high priority processing.

The reason is because the server status storing unit 3110 stores the priority of the processing being executed by a processing server 320, and the data processing request includes the priority of the requested new data processing, and if the latter priority is higher, it makes the processing server 320 transmit data regardless of the current load.

### Second Exemplary Embodiment

The second exemplary embodiment will be described in detail with reference to drawings. The distributed processing management server 310 of this exemplary embodiment performs a processing allocation decision having also an equalization effect of data volume which each processing server 320 processes.

The processing allocation unit 314 of this exemplary embodiment uses information on the processing capability of processing server 320 stored in the server status storing unit 3110. The information on the processing capability is a quantified index such as the clock speed or the number of cores of CPU, or similar to that.

As a method used by the processing allocation unit 314 of this exemplary embodiment, there are a method to include the processing capability index in the constraint equation and a method to include it in the objective function. The processing allocation unit 314 of this exemplary embodiment may be realized by using any of the methods.

In the following formula, pj is a ratio of the processing capability of the processing server j belonging to VN, and it is ΣjεVNpj=1. The processing allocation unit 314 refers to load information 3112 and configuration information 3113 in the server status storing unit 3110, and computes the available processing capability ratio pj of each usable processing server j acquired by the load computation unit 313.

When including it in the constraint equation, formula 10B using the maximum allowance d′j of data volume processed in the processing server j is given to the processing allocation unit 314. For example, the processing allocation unit 314 computes d′j based on formula 10A. Here, a positive coefficient α (>0) is the value that specifies the degree of allowable error from allocation in accordance with the processing capability ratio considering the inter-server communications load, and is given to the processing allocation unit 314 as a system parameter or the like.

d′j=(1+α)pjΣiεVD di(∀jεVN) (10A)

s.t. ΣiεVD fij≦d′j(∀jεVN) (10B)

That is, the processing allocation unit 314 distributes the total data volume of the whole data servers 330 based on the processing capability ratio of the processing server 320, and the total volume of the data transmission and reception of each processing server 320 is constrained to receive up until the same data volume as this.

When it is not necessary to be allocated based on the ability ratio strictly, a system manager or the like gives a value of large a to the processing allocation unit 314. In this case, the processing allocation unit 314 minimizes the objective function with permiting existence of the processing server 320 which receives data volume beyond the ability ratio a little. Further, each processing server 320 performs data processing of the uniform amount when α=0 and pj=1/|VN|(∀jεVN) in case where |VN| is the number of elements of VN.

When including it in the objective function, the load computation unit 313 creates a communications load matrix C under the objective function indicated by formula 1, formula 2, formula 5 and formula 6 with a complete data unit quantity processing load c′ij as an element. The complete data unit quantity processing load c′ij is a value in which the server processing load is added to the complete data unit quantity processing load cij, and is given by formula 11.

Here, β is processing time per unit data volume and for example, is given to the processing allocation unit 314, for each data processing (processing program), by written in a structure program or designated as a system parameter of the distributed processing management server 310. The server processing load is a value that normalized this β with respect to the processing capability ratio pj of each server.

c′ij∝cij+β/pj (∀iεVD,∀jεVN) (11)

That is, according to increase of the communication volume from the data server i to the processing server j, cij is added to the value of the objective function, and at the same time, the load which is proportional to a reciprocal of processing capability of the processing server j is added.

This system is useful particularly to a case for minimizing the maximum value of the total complete data processing load per processing server 320 in such as a case where the objective function is formula 2. For example, when cij is a reciprocal of network band, the processing allocation unit 314 determines the data transmission and reception between servers so that it may reduce the time for the processing server 320 which has the largest sum of reception time for receiving the total value of data that the processing server j receives and processing time after the reception.

The additional effect of this distributed system 340 is that it can minimize the objective function with considering not only the communications load received by the processing server 320 but also the processing capability of the processing server 320. As a result, for example, it is possible to realize equalization of time point of completion of both of data reception and processing for each processing server 320.

The reason why the effect occurs is that it includes the computation capability of each processing server 320 into the constraint equation or the objective function in minimization of the objective function.

### Third Exemplary Embodiment

The third exemplary embodiment will be described with reference to drawings. The data processing server 320 of this exemplary embodiment inputs data elements from a data set of a plurality (N) of data and performs data processing.

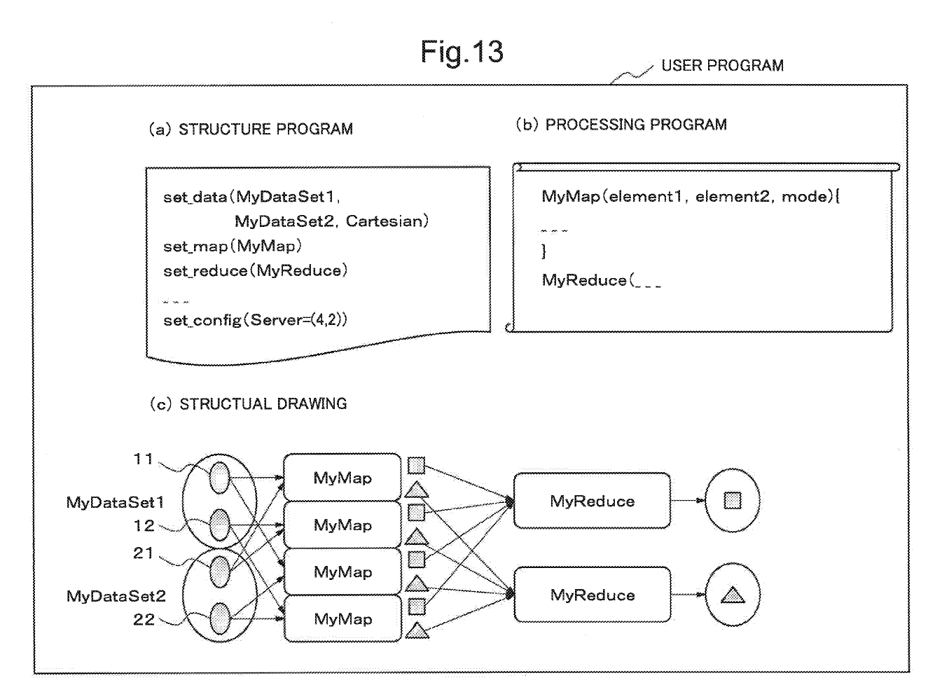

FIG. 13 exemplaifies a user program inputted to a client 300 of this exemplary embodiment. The structure program of FIG. 13 is describing to process the cartesian product (designated by cartesian designation of set_data phrase) of two data sets named MyDataSet1 and MyDataSet2. This structure program is describing to execute a processing program named MyMap first, and apply a processing program named MyReduce to the output result. Further, the structure program is describing (Server designation of set_config phrase) that it should process MyMap by four units, MyReduce by two units of processing servers 320 in parallel. FIG. 13(c) is a figure expressing this structure.

The data composed of the cartesian product of two data sets named MyDataSet1 and MyDataSet2 is the combination data composed of data elements 11 and 12 included in the former and data elements 21 and 22 included in the latter. Specifically, four pairs of data of (element 11 and element 21), (element 12 and element 21), (element 11 and element 22) and (element 12 and element 22) are inputted to MyMap.

The distributed system 340 of this exemplary embodiment can be used for arbitrary processing which requires a cartesian product operation between sets. For example, when the processing is JOIN among a plurality of tables in a relational database, two data sets are tables and data elements 11-12 and 21-22 are rows included in the table. The MyMap processing using a group of a plurality of data elements as the arguments is, for example, a join processing between tables declared by the Where paragraph of SQL.

The processing of MyMap may be data processing of a matrix or a vector. In this case, the matrix or the vector is a data set and a value in the matrix or the vector becomes a data element.

In this exemplary embodiment, each data set may take any distributed form 3122 such as a simple distributed arrangement, a redundant distributed arrangement and an encoded distributed arrangement or the like (refer to FIG. 5B and FIG. 6A). The explanation below is a case of the simple distributed arrangement.

In this exemplary embodiment, the set of groups of element obtained from a plurality of data sets designated by the structure program becomes a complete data set. Accordingly, a data server list becomes a list of data servers 330 which store any of partial data set of each data set. When processing the cartesian product of a plurality of data sets as directed in FIG. 13, a set of data lists becomes all combinations of the list of data servers 330 which store any of partial data set of each data set.

In other words, the set of data server lists becomes a set composed of the list of data servers 330 which are obtained by the cartesian product of the set of data servers 330 which store the partial data sets of a plurality of processing object data sets.

Further, the complete data unit quantity acquisition load cij in this exemplary embodiment becomes the communications load for a processing server j to acquire unit data volume (for example, one data element) respectively from each data server 330 belonging to the server list i. Accordingly, cij becomes the summation of the inter-server communications load between the processing server j and each data server 330 belonging to the server list i.

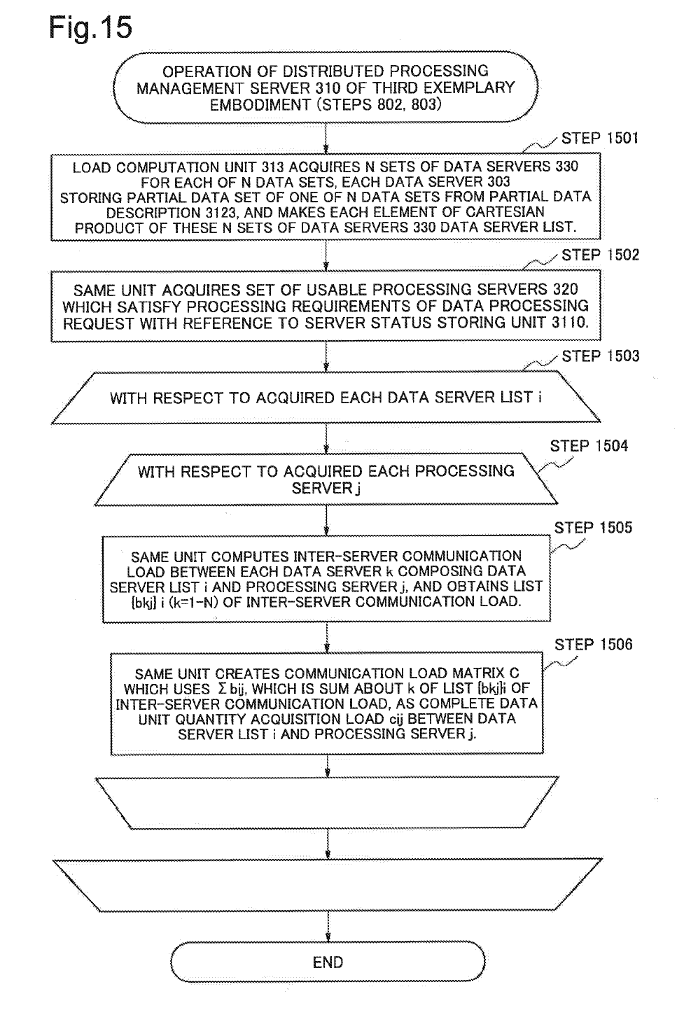

FIG. 15 is an operation flowchart of the distributed processing management server 310 of the third exemplary embodiment in Steps 802 and 803 (FIG. 8). That is, in this exemplary embodiment, FIG. 10 and FIG. 11 are replaced by this figure.

With respect to each of N data sets which become processing objects, the load computation unit 313 acquires a set of data servers 330 each storing the partial data set of the data set from the partial data description 3123 of the data location storing unit 3120. Next, this same unit obtains the cartesian product of these N sets of data servers 330, and makes each element of this cartesian product a data server list (Step 1501).

This same unit acquires a set of usable processing servers 320 which satisfy processing requirements of a data processing request with reference to the server status storing unit 3110 (Step 1502).

This same unit executes the following processing for the combination of each data server list I (Step 1503) acquired in the above-mentioned step and each server j (Step 1504) in the processing server 320 set.

This same unit computes the inter-server communications load between each data server k composing the data server list i and the processing server j, and obtains the list {bkj}i (k=1−N) of the inter-server communications load (Step 1505). Further, when each partial data set is multiplexed or encoded, this same unit computes each inter-server communications load by a method indicated in the fourth exemplary embodiment which will be described later.

This same unit creates a communications load matrix C which uses Σbij, which is the sum about k of the list {bkj}i of the inter-server communications load, as the complete data unit quantity acquisition load cij between the data server list i and the processing server j (Step 1506).

Further, when the summation of data volume of each data set is not uniform, the load computation unit 313 uses the sum which is weighted by a size ratio of the data element for each data set as the complete data unit quantity acquisition load cij. When the number of data elements of each data set is identical, it may weight by a data volume ratio of the data set instead of giving weight by the size ratio of the data element.

The processing allocation unit 314 performs minimization or the like (after Step 804 of FIG. 8) of the objective function using the communications load matrix C which has been created here.

The user program which the distributed system 340 of this exemplary embodiment inputs is not limited to a program which processes the cartesian product of a plurality of data sets. For example, the user program may include a processing program which selects, one by one from each of a plurality of data set, a data element which is associated by having an identical order or identical identifier or the like, and processes a group composed of the selected data elements.

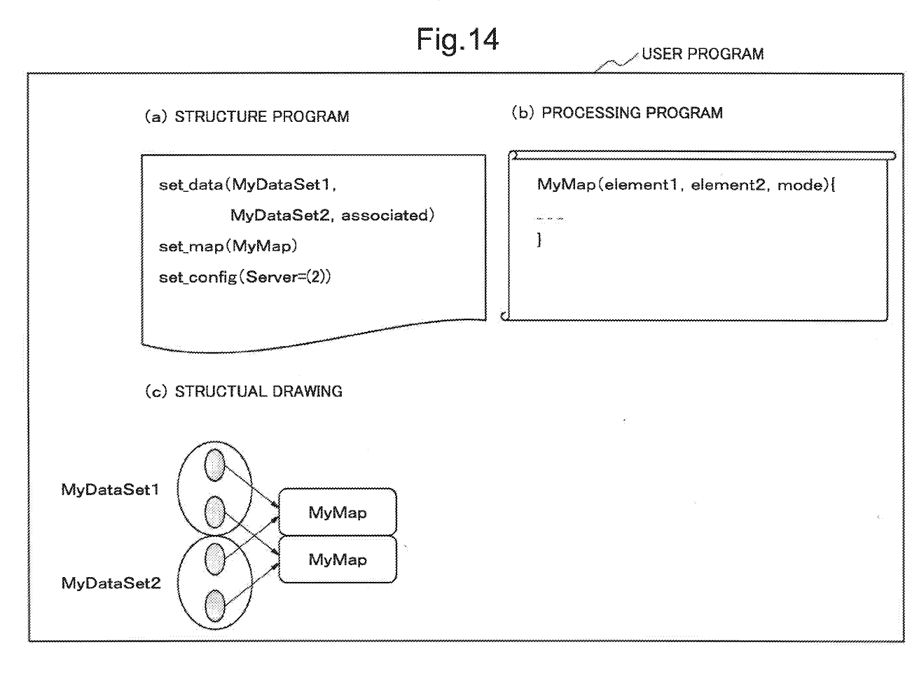

This user program is such a program which processes a data element group (a pair in this case) of the identical order in two data sets, for example, as MyDataSet1 and MyDataSet2. FIG. 14 is an example of such a program. The structure program in such a user program is describing that, for example, it makes the related data element group of two designated data sets a processing object (designated by associated designation of set_data phrase).

In the program of FIG. 14, the set of groups of element obtained from a plurality of data sets designated by the structure program becomes a complete data set similar to the case in a program of FIG. 13. Accordingly, the data server list becomes the list of data servers 330 which store any of partial data sets of each data set.

However, when processing the related data element pair of a plurality of data sets as shown in FIG. 14, the set of data server lists is different in case of the user program of FIG. 13. The load computation unit 313, instead of Step 1501 of FIG. 15, for example, divides each of a plurality of data sets which become processing objects into partial data sets with the size proportional to the data volume, and acquires a set of the lists of data servers 330 which store the group of each partial data set of the same order. The acquired set of the lists is the set of data server lists.

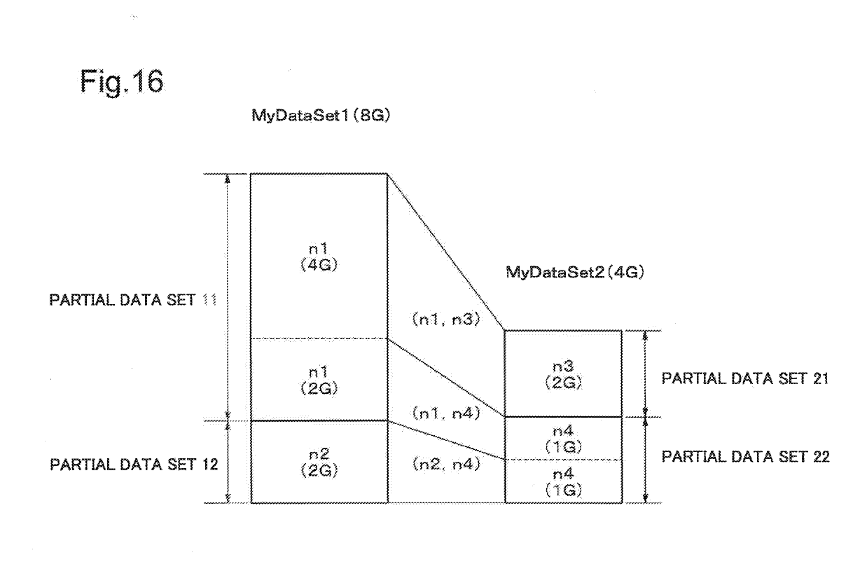

FIG. 16 exemplifies the set of data server lists at the time of the associated designation which associates by the appearance order of data element. In this figure, MyDataSet1 having the data volume of 8 GB is composed of partial data set 11 of 6 GB stored on the data server n1 and partial data set 12 of 2 GB stored on the data server n2.

MyDataSet2 having the data volume of 4 GB is composed of partial data set 21 of 2 GB stored on the data server n3 and partial data set 22 of 2 GB stored on the data server n4.

In this case, the load computation unit 313 divides MyDataSet1 and MyDataSet2 into segments by the data capacity ratio (8:4=2:1) and composes a pair in a sequence (Step 1501). As a result, this same unit obtains three pairs of partial data sets of (4 GB of the first half of partial data set 11, partial data set 21), (2 GB of the second half of partial data set 11, 1 GB of the first half of partial data set 22) and (partial data set 12, 1 GB of the second half of partial data set 22). This same unit obtains the sets of (n1, n3), (n1, n4) and (n2, n4) as the set of data server lists which store these partial data set pairs.

The after processing is same as FIG. 15.

The additional effect of the distributed system 340 of this exemplary embodiment is that it can realize processing arrangement which reduces a prescribed summation of the network load, even when the processing server 320 processes by inputting a group of a plurality of data elements belonging to each of a plurality of data sets.

The reason is because the processing server 320 computes the communications load cij for acquiring N groups of data elements, and performs minimization of the objective function based on the cij.

### Fourth Exemplary Embodiment

The fourth exemplary embodiment will be described with reference to drawings. The distributed system 340 of this exemplary embodiment handles multiplexed data or encoded data.

A program example inputted to a client 300 of this exemplary embodiment may be any of showen in FIG. 4, FIG. 13 and FIG. 14. For the sake of simplicity of explanation, in the following, it is supposed that an inputted user program example is the one shown in FIG. 4. However, it is supposed that the processing object data set designated by set_data phrase is MyDataSet5 exemplified in FIG. 6A.

As MyDataSet5 exemplifies, the data set of processing objects is stored in a different data server 330 for each of the partial data set. When some of the partial data sets of the data set is multiplexed (such as SubSet1 of FIG. 6A), the identical data is reproduced and distributed storage in a plurality of data servers 330 (for example, data servers jd1, jd2) is performed. Multiplexing is not limited to duplication. The data servers jd1, jd2 in FIG. 6A, for example, correspond to servers 511, 512 of FIG. 5B.

For some of the partial data sets, such as SubSet2 of FIG. 6A, of the data set, data is divided and made redundant using Erasure encoding or the like, and each of different data chunks which compose one partial data set and having the same size is stored in different data servers 330 (for example, data servers jel-jen) each other. The data servers jel-jen in FIG. 6A correspond, for example, to the servers 531-551 of FIG. 5B.

In this case, the partial data set (such as SubSet2) is divided into a certain redundant number n of data chunks, and when a constant minimum acquisition number k (k<n) or more of data chunks among these n chunks, the partial data set can be restored. In the case of multiplex, as the whole, it needs as much data volume as multiplicity times of the original data volume, however, in the case of Erasure encoding, several ten percent extra of the original partial data set volume may be enough.

Further, the load computation unit 313 may be realized so that it may also handle the partial data set, for which reproduction is distributed arranged by Quorum, similar to the encoded partial data set. Quorum is a method to read and write distributed data with keeping consistency. The reproduced number n and the reading constant number and writing constant number k are stored in the distributed form 3122 and given to the load computation unit 313. The load computation unit 313 handles the reproduced number by replacing to the redundancy number and the reading constant number and writing constant number by replacing to the minimum acquisition number.

In case of the user program of FIG. 4, each partial data set is a complete data set. When partial data set i is multiplexed in n layers, the complete data unit acquisition load cij becomes the load for receiving unit communication volume from arbitrary one of n data servers i1-in (data server list) which store multiplexed data of the partial data set i. Accordingly, the load computation unit 313 determines that the complete data unit acquisition load cij is the minimum one among the inter-server communications loads between each of the data servers i1-in and the processing server j.

When partial data set i is made redundant by Erasure encoding or Quorum, the complete data unit acquisition load cij becomes the load for receiving unit communication volume from arbitrary k servers among n data servers i1-in (data server list) which store redundant data chunks of the partial data set i. Accordingly, the load computation unit 313 determines that the complete data unit acquisition load cij is one in which smallest k peices of load are added among the inter-server communications loads between each of the data servers i1-in and the processing server j.

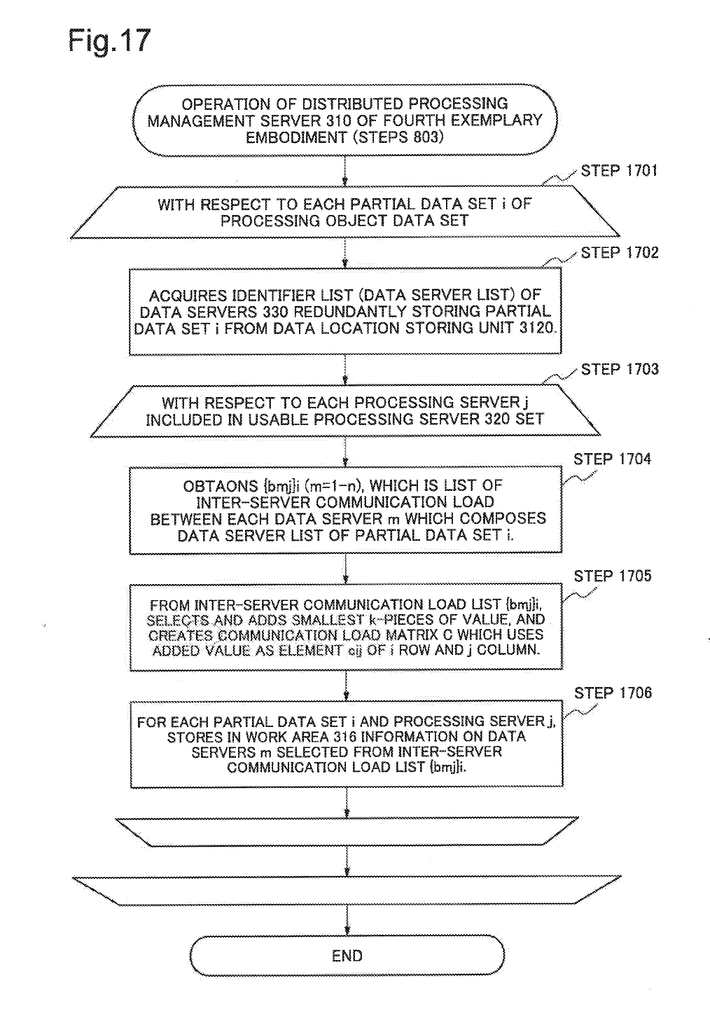

FIG. 17 is an operation flowchart of the distributed processing management server 310 of the fourth exemplary embodiment in Step 803 (FIG. 8). That is, in this exemplary embodiment, FIG. 11 is replaced by this figure. Further, this figure is a flowchart in case where each partial data set is made redundant by Erasure encoding or Quorum. When k is replaced with 1, this figure becomes a flowchart corresponding to the multiplexed partial data set.

With respect to each partial data set i of the processing object data set (Step 1701), the load computation unit 313 acquires an identifier list (data server list) of data servers 330 which store partial data set i redundantly from the data location storing unit 3120 (Step 1702).

With respect to each processing server j included in the set of usable processing servers 320 (Step 1703), this same unit obtains {bmj} i (m=1−n) which is a list of the inter-server communications load between the processing server j and each data server m which composes the data server list of partial data set i (Step 1704). This same unit takes out the smallest k peices of value from the inter-server communications load list {bmj} i and adds them, and creates a communications load matrix C which uses the added value as the element cij, which is complete data unit quantity acquisition load between partial data set i and processing server j, at i row and j column (Step 1705).

This same unit stores, for each partial data set i and processing server j, the information on the data servers m selected from the inter-server communications load list {bmj} i, in the work area 316 (Step 1706).

The processing allocation unit 314 performs minimization or the like (after Step 804 of FIG. 8) of the objective function using the communications load matrix C created here.

Also, there is a case that each of a plurality of data chunks which compose the multiplexed or encoded partial data set i is further multiplexed or encoded. For example, it is a case such that one of the composed data chunks of the duplicated partial data set i is multiplexed and other one is encoded. Or, it is a case such that among three chunks which compose the encoded partial data set i, one chunk is duplicated and two other chunks are encoded to each of the three chunks. Thus, the partial data set i is sometimes multiplexed or encoded in multiple steps. Combination of methods for multiplexing and encoding in each step may be free. The number of steps is also not limited to two steps.

In this kind of case, the row corresponding to the partial data name 3127 (for example, SubSet1) of FIG. 6A includes the partial data name 3127 (for example, SubSet11, SubSet12 . . . ) of the lower step instead of the partial data description 3123. And, the data location storing unit 3120 also includes the row corresponding to those SubSet11, SubSet12 . . . . In Step 1702 of FIG. 17, the load computation unit 313, which has referred to such data location storing unit 3120, acquires the data server list having nest structure to the partial data set i. Further, this same unit carries out the inter-server communications load addition of Step 1705 in the order of depth of the nest for each of the nested each data server lists, and creates a communications load matrix C finally.

In such a case that n chunks which compose the encoded partial data set are chunks composed of data pieces which the partial data set was divided into a plural number and chunks composed of parity information, a processing server 320 requires the set (recoverable set) of specific k chunks in order to restore the partial data set.

In this case, it is unable for the load computation unit 313 to perform in Step 1705 “takes out the smallest k pieces of value from {bmj} i and adds them, and uses the added value as the element cij at i row and j column”. Instead, this same unit uses the minimum decodable communications load ij as cij. The minimum decodable communications load ij is the minimum one among addition values of the elements of {bmj}i relating to a data server mi which stores each chunk belonging to each recoverable set i of the partial data set i.

Here, bmj is a load in consideration of data volume of a piece m. Further, at the time a chunk is formed, it is described in attribute information of each chunk which chunk composes each of the specific k chunks. The load computation unit 313 identifies the chunk belonging to each recoverable set with reference to the information.

For example, when the partial data set i is encoded to six chunks of {n1,n2,n3,n4,p1,p2}, the load computation unit 313 searches for, for example, two recoverable sets of Vm{n1,n2,n4,p1,p2} and {n1,n2,n3,p1,p2} from the attribute information of the chunks. In these two recoverable sets Vm, this same unit determines ΣmεVm{bmj}i, which is relating to the Vm where ΣmεVm{bmj}i becomes minimum, as cij.

Further, when the specific k chunks are arbitrary k chunks, the result is same which value is determined as cij. That is, the latter processing is the processing generalizing the former.

The additional effect of the distributed system 340 of this exemplary embodiment is that it is possible to reduce a network load involved in data transfer using redundancy when the data set is made redundant (multiplexed, encoding). The reason is because the distributed processing management server 310 determines communication volume between the servers for each processing server 320 so that data transmission is performed with priority from the data servers 330 having low inter-server communications load with the processing server 320.

### Fifth Exemplary Embodiment

The fifth exemplary embodiment will be described with reference to drawings. In the distributed system 340 of this exemplary embodiment, each processing server j receives data of identical proportion wj, which is determined for each processing server 320, from all data servers 330.

A program example inputted to a client 300 of this exemplary embodiment may be any of shown in FIG. 4, FIG. 13 and FIG. 14. For the sake of simplicity of explanation, in the following, it is supposed that an inputted program example is the one shown in FIG. 4.

The program of FIG. 4 describes to apply the processing program of MyReduce to a data set which the processing program of MyMap has outputted. MyReduce processing is, for example, the processing which inputs data elements of the output data set of MyMap processing, arranges in data elements having a condition which is predetermined or given by a structure program or the like, and creates a plurality of unified data sets. The processing like this is, for example, processing named Shuffle or GroupBy.

MyMap processing is, for example, the processing which inputs a set of Web pages, pulls out words from each page, and outputs the number of occurrences in the page together with the pulled out word as output data set. MyReduce processing is, for example, the processing which inputs this output data set, checks the number of occurrences of all words in all pages, and adds the result of the identical word throughout all pages. In the processing like this program, there may be a case that a processing server 320 of MyReduce processing, which performs Shuffle or GroupBy processing for a constant proportion among all words, acquires a constant proportion of data from all of the processing servers 320 of MyMap processing in the preceding stage.

The distributed processing management server 310 of this exemplary embodiment is used when a processing server 320 in the succeeding stage processing is to be decided in this kind of situation.

Further, the distributed processing management server 310 of this exemplary embodiment can be realized so that it may handle the output data set of MyMap processing similar to the input data set in the first to fourth exemplary embodiments. That is, the distributed processing management server 310 of this exemplary embodiment can be configured to function that it regards the processing server 320 in the preceding stage processing, i.e., the processing server 320 which stores the output data set of the preceding stage processing as the data server 330 in the succeeding stage processing.

Or, the distributed processing management server 310 of this exemplary embodiment may find data volume of the output data set of MyMap processing by performing estimation or the like from data volume of the input data set of MyMap processing and an expectation value of the input/output data volume ratio of MyMap processing. The distributed processing management server 310 can determine a processing server 320 of MyReduce processing before completion of MyMap processing by finding an estimated value.

The distributed processing management server 310 of this exemplary embodiment receives a decision request of a Reduce processing execution server, and minimizes the objective function of formula 1 or formula 2 (Step 804 of FIG. 8) like a distributed processing management server 310 of the first to fourth exemplary embodiment. However, the distributed processing management server 310 of this exemplary embodiment minimizes the objective function by adding the constraints of formula 12 and formula 13.

The di in the formula is data volume of a data server i. As mentioned above, this value is, for example, the output data volume of MyMap processing or the predicted value. The wj expresses a proportion of which a processing server j takes charge.

As a result of such constraints, the processing allocation unit 314 minimizes the objective function under the condition that data of constant rate wj is transmitted from all data servers i to a processing server j.

s.t. fij/di=wj(∀iεVD,∀jεVN) (12)

s.t. ΣjεVN wj=1, wj≧0 (∀jεVN) (13)

When formula 1 and formula 2 are rewritten using formula 12, minimization of the objective function with a variable of fij becomes minimization of the objective function with a variable of wj like formula 14 and formula 15. The processing allocation unit 314 may be realized such that it obtains wj by minimization of formula 14 or formula 15 and computes fij from that.

min. ΣjεVN(ΣiεVD dicij)wj (14)

min. MaxjεVN(ΣiεVD dicij)wj (15)

Apart from the above-mentioned point (Step 804 of FIG. 8), the distributed system 340 of this exemplary embodiment operates similar to the first to fourth exemplary embodiments (FIG. 8 or the like). That is, using the computed result, the processing allocation unit 314 obtains how much volume of data are to be processed by which processing server 320. Moreover, this same unit determines, from wj or fij, a processing server j which the communication volume is not 0, and determines that the processing server j should acquire how much volume of data from each data server i.

There is a case that each processing server 320 of the distributed system 340 is responsible for a certain amount of load in advance. The distributed processing management server 310 of this exemplary embodiment may be realized such that it performs minimization of formula 2 by reflecting the load. In this case, the processing allocation unit 314 minimizes formula 16 as the objective function instead of formula 2. That is, this same unit determines fij so that a processing server j, which has the maximum total value of the additional value in which the load δj of the processing server j is also added to the complete data processing load fijc'ij (fijcij when the server processing load is not considered), may take the minimum additional value.

The load δj is a value which is set when any communications loads or processing loads are indispensable in advance in order to use the processing server j. The load δj may be given to the processing allocation unit 314 as a system parameter or the like. The processing allocation unit 314 may receive the load δj from the processing server j.

When the processing server 320 performs data aggregation like Shuffle processing, the constraints of formula 12 and formula 13 are applied, and the objective function of formula 16 becomes a function with a variable of wj like formula 17. The processing allocation unit 314 is realized such that it obtains wj by minimization of formula 17, and computes fij from that.

min. MaxjεVNΣiεVD cijfij+δj (16)

min. MaxjεVN(ΣiεVD dicij)wj+δ (17)

The first additional effect of the distributed system 340 of this exemplary embodiment is that it can reduce the communications load under the condition that fixed proportion of data of each data server 330 is delivered to a plurality of processing servers 320. The reason is because the objective function is minimized by adding proportional information to a constraint condition.

The second additional effect of the distributed system 340 of this exemplary embodiment is that even when a processing server 320 has any load in advance, and when processing (received data) is assigned to the processing server 320, it can assign the processing to the processing server 320 with considering the load. By this, the distributed system 340 can reduce dispersion at the time of processing completion in each processing server 320.

The reason why this effect is obtained is because it is possible to minimize the objective function, particularly minimization of a maximum load, with including the load currently born by the processing server 320.

In such a case where the succeeding processing performs by receiving an output of the preceding stage processing, the distributed system 340 of this exemplary embodiment is also effective in communications load reduction at the time of transmitting the output of the preceding stage processing to a processing server 320 of the succeeding processing. The reason is because the distributed processing management server 310 of this exemplary embodiment can function that it regards the processing server 320 in the preceding stage processing, i.e., the processing server 320 which stores the output data set of the preceding stage processing as a data server 330 in the succeeding stage processing. The similar effect can be obtained from the distributed system 340 of the first to fourth exemplary embodiments.

### Description According to a Specific Example for Each Exemplary Embodiment

### Specific Example of First Exemplary Embodiment

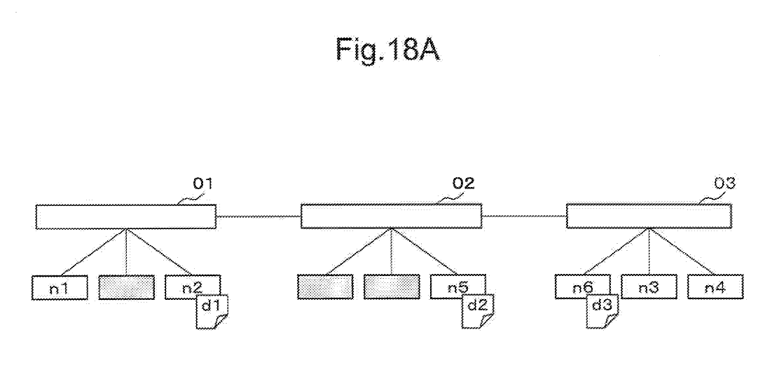

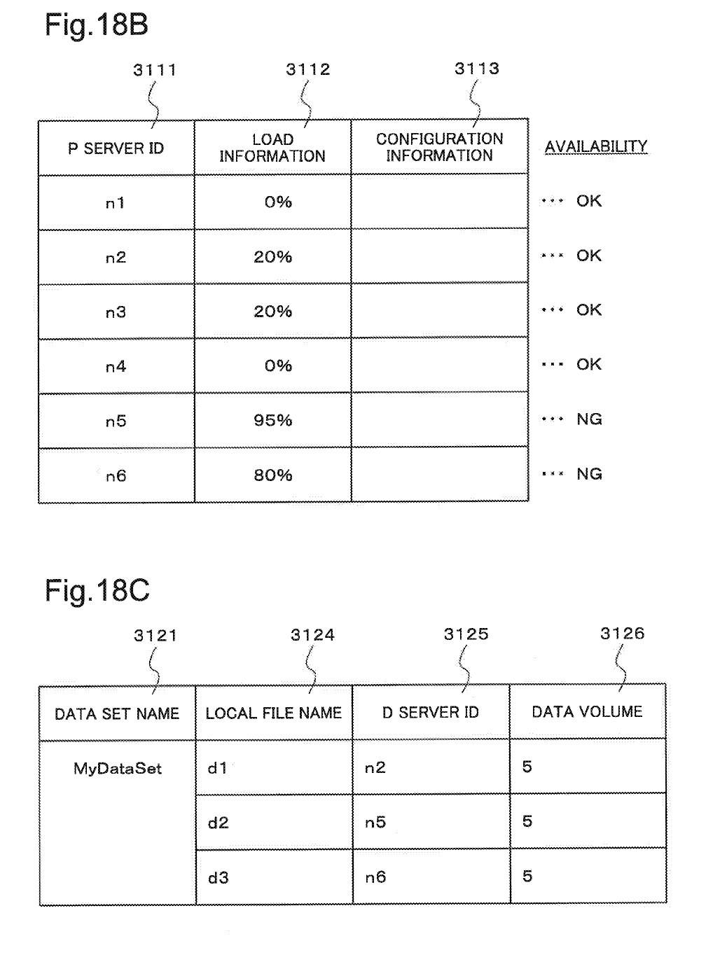

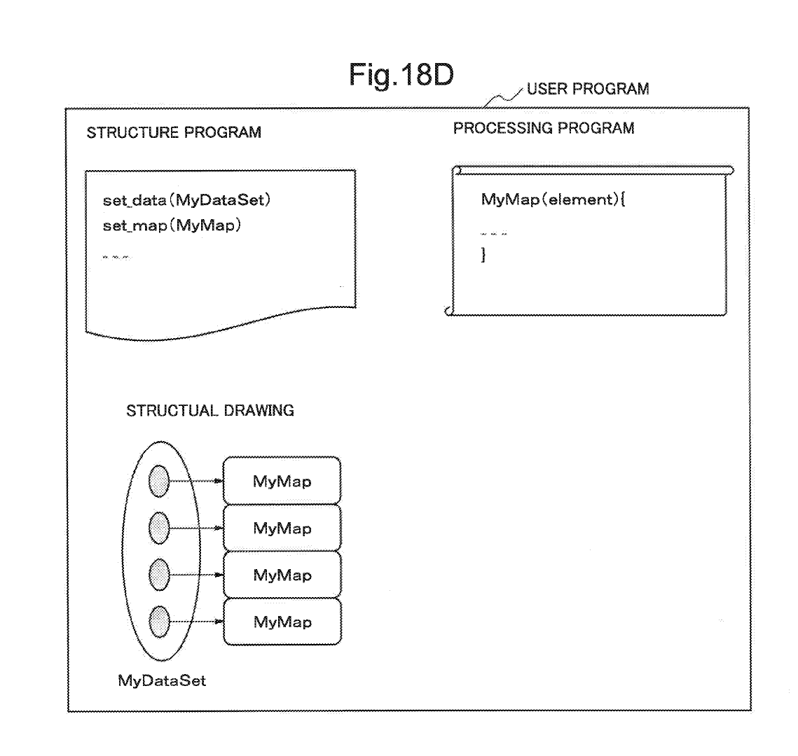

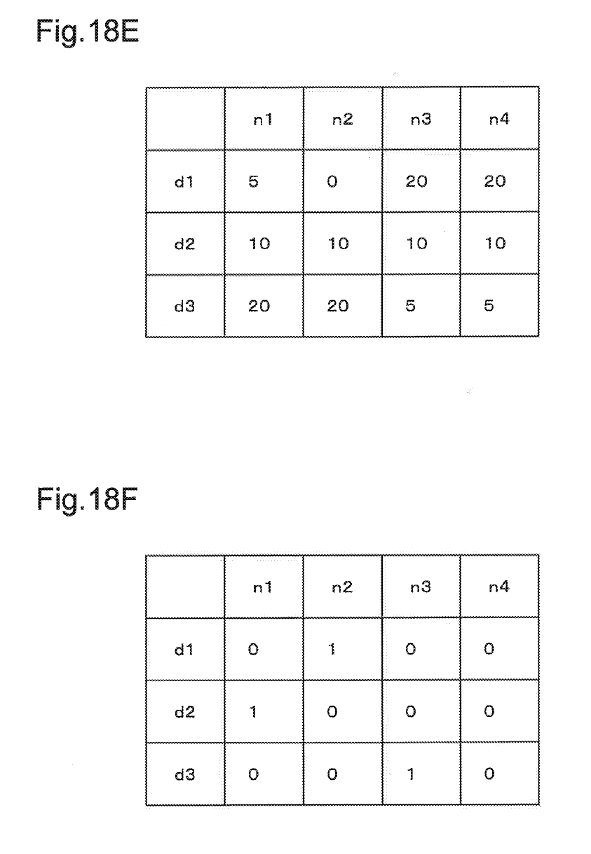

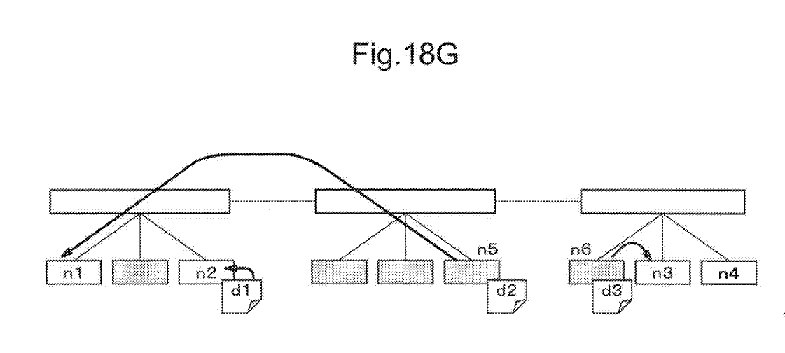

FIG. 18A indicates a configuration of the distributed system 340 used for this specific example or the like. Operation of the distributed system 340 of each exemplary embodiment mentioned above will be described using this figure. This distributed system 340 is composed of servers n1-n6 connected by switches 01-03.

The servers n1-n6 function as a processing server 320 and a data server 330 depending on the situation. Each of the servers n2, n5 and n6 stores partial data set d1, d2 and d3 of a certain data set respectively. In this figure, any of the servers n1-n6 functions as a distributed processing management server 310.

FIG. 18B indicates information stored in the server status storing unit 3110 provided in the distributed processing management server 310. Load information 3112 stores a CPU usage rate. When a server is carrying out other computation processes, the CPU usage rate of this server becomes high. The load computation unit 313 of the distributed processing management server 310 compares the CPU usage rate of each server with a predetermined threshold value (50% or less or the like), and judges whether each server can be used. In this example, the servers n1-n5 are judged to be usable.

FIG. 18C indicates information stored in the data location storing unit 3120 provided in the distributed processing management server 310. The data shows that each of 5 GB partial data sets of the data set MyDataSet is stored in servers n2, n5 and n6. MyDataSet is simply distributed arranged (FIG. 5B (a)), and multiplexing and encoding (FIG. 5B (b), (c)) are not performed.

FIG. 18D indicates a user program inputted to a client 300. This user program describes that it should process the data set MyDataSet by a processing program named MyMap.

When this user program is inputted, the client 300 interprets a structure program and a processing program and transmits a data processing request to the distributed processing management server 310. At that time, it is supposed that the server status storing unit 3110 is the situation shown in FIG. 18B and the data location storing unit 3120 is the situation shown in FIG. 18C.

The load computation unit 313 of the distributed processing management server 310 refers to the data location storing unit 3120 of FIG. 18C and obtains {n2, n5, n6} as a set of data servers 330. Next, this same unit obtains {n1, n2, n3, n4} from the server status storing unit 3110 of FIG. 18B as a set of processing servers 320.

This same unit creates a communications load matrix C, about each of the whole combinations of each one element selected from each of the sets ({n2, n5, n6}, {n1, n2, n3, n4}) of these two servers, based on the inter-server communications load.

FIG. 18E indicates the created communications load matrix C. In this specific example, the load between servers is the number of switches existing on the communication route between servers. The number of switches between servers is given to the load computation unit 313 in advance, for example, as a system parameter. Also, the inter-server load acquisition unit 318 may acquire information on the configuration using a configuration management protocol and give to the load computation unit 313.

When the distributed system 340 is a system to identify a network connection from an IP address of a server, the inter-server load acquisition unit 318 may acquire an IP address from an identifier of a server such as n2 and obtain the inter-server communications load.

FIG. 18E indicates the communications load matrix C in which the inter-server communications load is supposed to be 0 within the same server, 5 between servers in the same switch and 10 for a connection between switches.

The processing allocation unit 314 initializes a flow rate matrix F based on the communications load matrix C of FIG. 18E, and minimizes the objective function of formula 1 under the constraints of formula 3 and formula 4.

FIG. 18F indicates a flow rate matrix F obtained as a result of the objective function minimization. The processing allocation unit 314 transmits a processing program obtained from a client 300 to n1-n3 based on the obtained flow rate matrix F, further transmits decision information to the processing servers n1, n2 and n3 and instracts data reception and processing execution. The processing server n1 which has received the decision information acquires data d2 from the data server n5 and processes it. The processing server n2 processes data dl on the data server n2 (the same server). The processing server n3 acquires data d3 on the data server n6 and processes it. FIG. 18G indicates data transmission and reception determined based on the flow rate matrix F of FIG. 18F.

### Specific Example of Second Exemplary Embodiment

In a specific example of the second exemplary embodiment, a data set of a processing object is distributed to a plurality of data servers 330 with different data volume. Data of one data server 330 is divided, and the data is transmitted to a plurality of processing servers 320 and processed.

In this specific example, two examples will be explained in order to show the difference in the objective functions and the difference between the method to add an equalization condition of the load to the constraint equation and the method to include it in the objective function. The first example reduces the whole network load (formula 1), and the second example reduces a network load (formula 2) of the slowest processing. The first example includes an equalization condition of the load in the constraint equation. The second example includes an equalization condition of the load in the objective function. With respect to a communications load matrix, the first example uses a delay which is guessed from the topology of switchs and servers, and the second example uses an available band which is measured.

The configuration shown in FIG. 18A is also used for a specific example of the second exemplary embodiment. However, the data volume of data d1-d3 is not identical.

FIG. 19A indicates a user program inputted in a specific example of the second exemplary embodiment. A structure program of this program includes designation (set_config phrase) of processing requirements.

The server status storing unit 3110 in a specific example of the second exemplary embodiment is the same as FIG. 18B. However, configuration information 3113 corresponding to each processing server 320 includes the same number of CPU cores and the same CPU clock speed.

FIG. 19B indicates information stored in the data location storing unit 3120 in the first example of the second exemplary embodiment. The information shows that the data volume of partial data set d1, d2 and d3 are 6 GB, 5 GB and 5 GB respectively.

In the first example, the load computation unit 313 of the distributed processing management server 310 obtains {n1, n2, n3, n4} as a set of usable processing servers 320 from the server status storing unit 3110 (FIG. 18B) because the number of server units=4 is being designated as the processing requirements.

Next, this same unit refers to the data location storing unit 3120 of FIG. 19B and obtains {n2, n5, n6} as a set of data servers 330. This same unit obtains a communications load matrix C from these two sets and the inter-server communications load between each of servers. FIG. 19C indicates the communications load matrix C of the first example.

The processing allocation unit 314 obtains, from the data storing unit 312 of FIG. 19B, the data volume of partial data sets belonging to a processing object data set which each data server 330 stores. This same unit obtains the relative value of performance of each processing server 320 from the server status storing unit 3110. In the first example, this same unit obtains the processing capability ratio of 1:1:1:1:1 from the number of CPU cores and the CPU clock speed of each processing server 320.

When the communications load matrix C of FIG. 19C is obtained, this same unit minimizes the objective function of formula 1 under the constraints of formula 7, formula 8 and formula 10B using the data volume and performance relative value acquired by the above and also parameterα=0 given in advance. The data volume of each data server 330 is 6 GB, 5 GB and 5 GB respectively as mentioned above.

Because the performance relative value of each processing server 320 is identical, all processing servers n1-n4 procese the data of 4 GB. As a result of this minimization, this same unit obtains the flow rate matrix F of FIG. 19D.

The summation of the product (complete data processing load) of the flow rate of the flow rate matrix F of FIG. 19D and the complete data unit quantity processing load (in this case, it is equivalent to the complete data unit quantity acquisition or the communications load between load servers) is 85. In a method which selects a neighboring processing server 320 successively for each data server 330, this total sometimes becomes 150.

In the first example, MyMap processing is carried out on all processing servers n1-n4 because the load computation unit 313 uses the number of server units designated by the processing requirements as the candidates of the usable processing server 320. Accordingly, the processing allocation unit 314 transmits a processing program obtained from a client 300 to the processing servers n1-n4.

Further, this same unit transmits decision information to each of the processing servers n1-n4 and instracts data reception and processing execution.

The processing server n1 which has received the decision information receives 2 GB portion of data dl from the data server n2 and 2 GB portion of data d2 from the data server n5 and processes them. The processing server n2 processes 4 GB portion of data dl on the same data server. The processing server n3 receives 1 GB portion of data d2 from the data server n5 and 3 GB portion of data d3 from the data server n6 and processes them. The processing server n4 receives 2 GB portion of data d3 from the data server n6 and 2 GB portion of data d2 from the data server n5 and processes them.

FIG. 19E indicates data transmission and reception determined based on the flow rate matrix F of FIG. 19D.

The operation of creating the flow rate matrix F from the communications load matrix C by minimization of the objective function by the processing allocation unit 314 (specific example of Step 804 of FIG. 8) will be explained below.

FIG. 19F is an operation flowchart example for creating a flow rate matrix F by the processing allocation unit 314. This figure exemplifies a flowchart using Hungarian method in a bipartite graph. FIG. 19G shows matrix conversion process in objective function minimization.

Further, the operation flowchart of objective function minimization is shown only here and will be omitted in the following examples. Therefore, FIG. 19F shows a case where there is a costraint of the received data volume in a processing server 320 when the data volume stored in each data server 330 is different in addition to the above-mentioned condition and setting.

First, the processing allocation unit 314, with respect to each row of the communications load matrix C, subtracts the minimum value of the row from the value in each column of the row, and performs the similar processing also for each column (Step 1801). As a result, from the matrix 00 (communications load matrix C) of FIG. 19G, the matrix 01 is obtained.

This same unit creates a bipartite graph composed of zero elements in the matrix 01 (Step 1802) and obtains the bipartite graph 11. Next, this same unit follows a processing vertex on the bipartite graph from a vertex where data volume remains, successively follows data vertexes on a route having a flow which has already been assigned from the processing vertex (Step 1804) and obtains a flow 12.

Because it cannot assign a flow from this state (in Step 1805, No), this same unit corrects the matrix 01 so that it may allow more load by adding a side 13 through which data can be flowed to the bipartite graph (Step 1806). As a result, this same unit obtains the matrix 02.

This same unit creates the bipartite graph once again from the matrix 02 (Step 1802), and searches for a route to the processing vertex which can assign a flow from the data vertex where data volume remains (Step 1804). At that time, a side to the data vertex from the processing vertex belongs to a side belonging to the flow which has already been assigned. An alternative path 14 of the search result reaches the processing vertex n4 from the data vertex d1 via the processing vertex n1 and the data vertex d2.

This same unit obtains the minimum amount of remaining data volume in the data vertex on the alternative path 14, data volume that can be assigned at the processing vertex and the flow volume which has already been assigned. This same unit adds this amount as a new flow to the side from the data vertex on the alternative path to the processing vertex, and subtracts from the flow which has already been assigned on the side from the processing vertex on this same route to the data vertex (Step 1807). As a result, this same unit obtains a flow 15. The flow 15 is a flow rate matrix F which minimizes the summation (formula 1) under this condition.

FIG. 19H indicates information stored in the data location storing unit 3120 in the second example of the second exemplary embodiment. The information shows that the data volume of partial data set d1, d2 and d3 are 7 MB, 9 MB and 8 MB respectively.

In the second example, the load computation unit 313 refers to the server status storing unit 3110 of FIG. 18B, and acquires a set {n1,n2,n3,n4} of usable processing servers 320. Next, this same unit also obtains a processing capability ratio 5:4:4:5 of each of servers with reference to the CPU usage rate in addition to the number of CPU cores and the CPU clock speed.

The inter-server load acquisition unit 318 measures an available band of the inter-server communication route, obtains the inter-sever communications load (2/minium bandwidth (Gbps) between servers ij) based on the measured value and gives to the load computation unit 313. It is supposed that the measured value is 200 Mbps between switches 01-02 of FIG. 19K (and FIG. 18A), 100 Mbps between switches 02-03, and 1 Gbps between servers in the switch.

In this specific example, processing timeβ=40 per unit data volume is given to the load computation unit 313. This value is determined by a system manager or the like based on actual measurement or the like, and is given to the load computation unit 313 as a parameter. The load computation unit 313 computes the complete data unit quantity processing load c′ij by complete data unit quantity acquisition load (=inter-server communications load)+20/9pj, and creates the communications load matrix C of FIG. 19I.

The processing allocation unit 314 minimizes the objective function of formula 2 under the constraints of formula 7 and formula 8 using this communications load matrix C. As a result of this minimization, this same unit obtains the flow rate matrix F shown in FIG. 19J.

This same unit transmits decision information to each of processing servers n1-n4 and instracts data reception and processing execution.

The processing server n1 which has received the decision information receives 4.9 MB portion of data d2 from the data server n5 and processes. The processing server n2 process 7 MB portion of data d1 being stored in itself, and further, receives 0.9 MB portion of data d2 from the data server n5 and processes. The processing server n3 receives 2.9 MB portion of data d2 from the data server n5 and processes. The processing server n4 receives 0.3 MB portion of data d2 from the data server n5 and 8 MB portion of data d3 from the data server n6 and processes.

FIG. 19K indicates data transmission and reception determined based on the flow rate matrix F of FIG. 19J.

By performing as above, the distributed processing management server 310 reduces communications load while smoothing processing taking the difference in the server processing performance into account.

### Specific Example of Third Exemplary Embodiment

A specific example of the third exemplary embodiment shows an example which inputs a plurality of data sets and processes. The distributed system 340 of the first example processes the cartesian product of a plurality of data sets (cartesian designation). This system holds each data set by distributing to a plurality of data servers 330 with the same amount of data.

The distributed system 340 of the second example processes a group of data elements to which a plurality of data sets are being associated (associated designation). This system distributes each data set to a plurality of data servers 330 with different amount of data. The number of data elements included in each data set is identical, and different in data volume (such as the size of data element).

The user program which the distributed system 340 of the first example inputs is a user program shown in FIG. 13. This program is describing that the processing program named MyMap is to be apply to each element included in the cartesian product of two data sets of MyDataSet1 and MyDataSet2. Although this program also describes about MyReduce processing, it is ignored in this example.

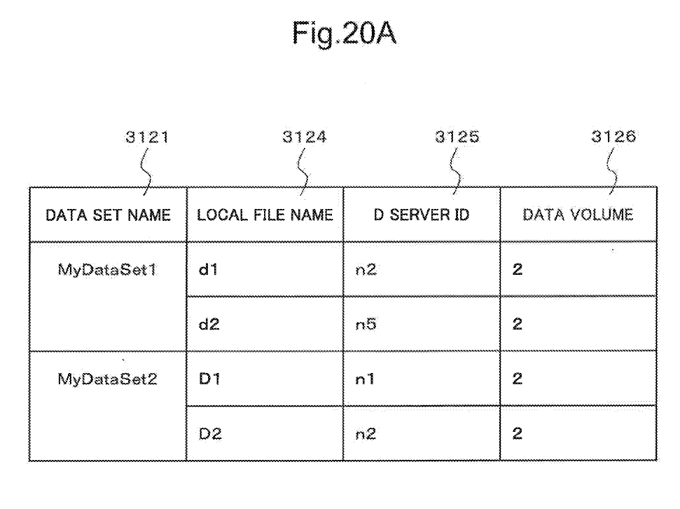

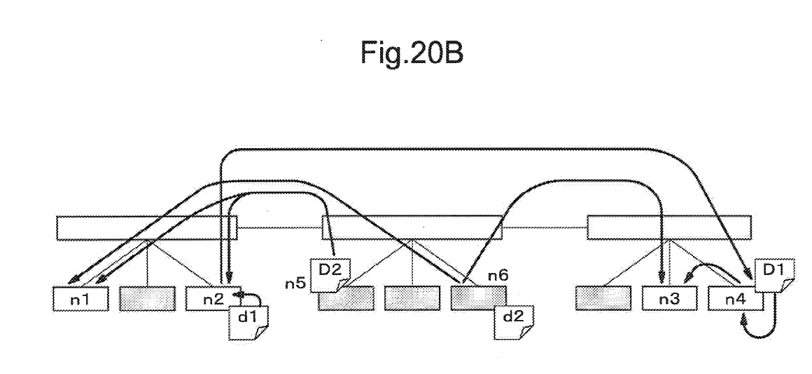

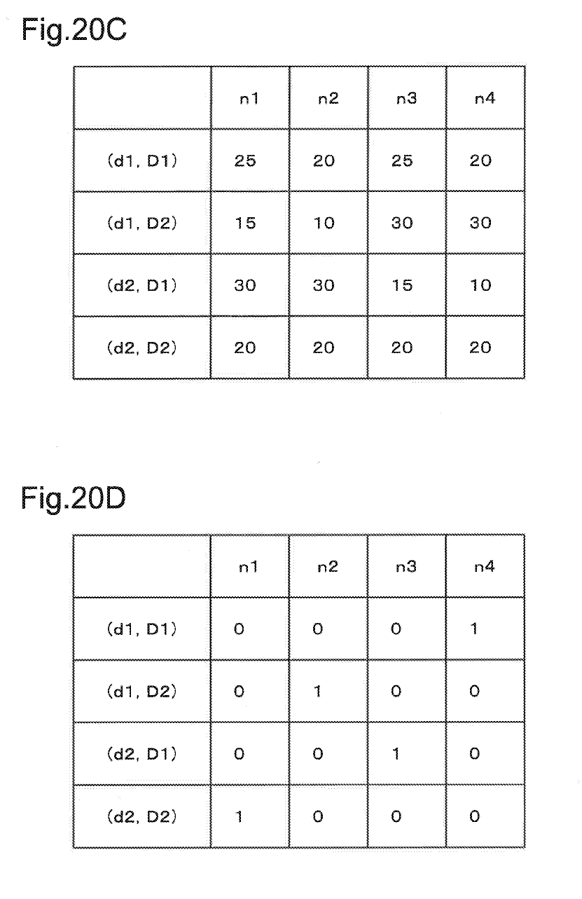

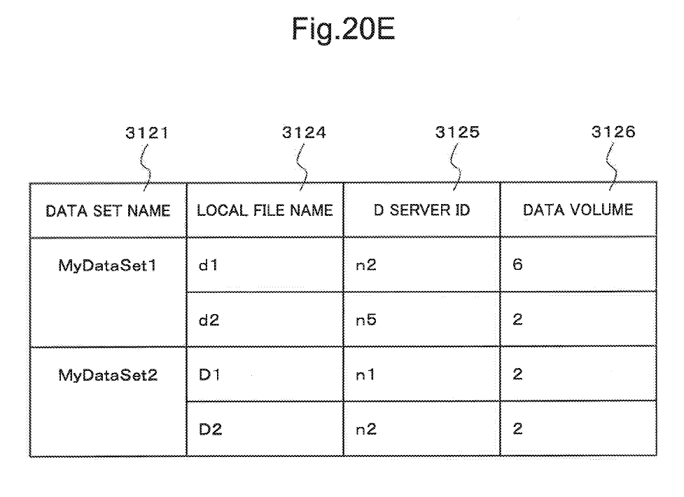

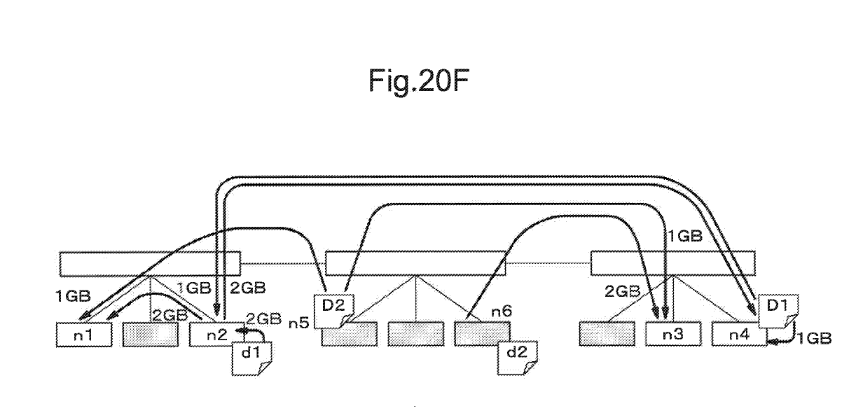

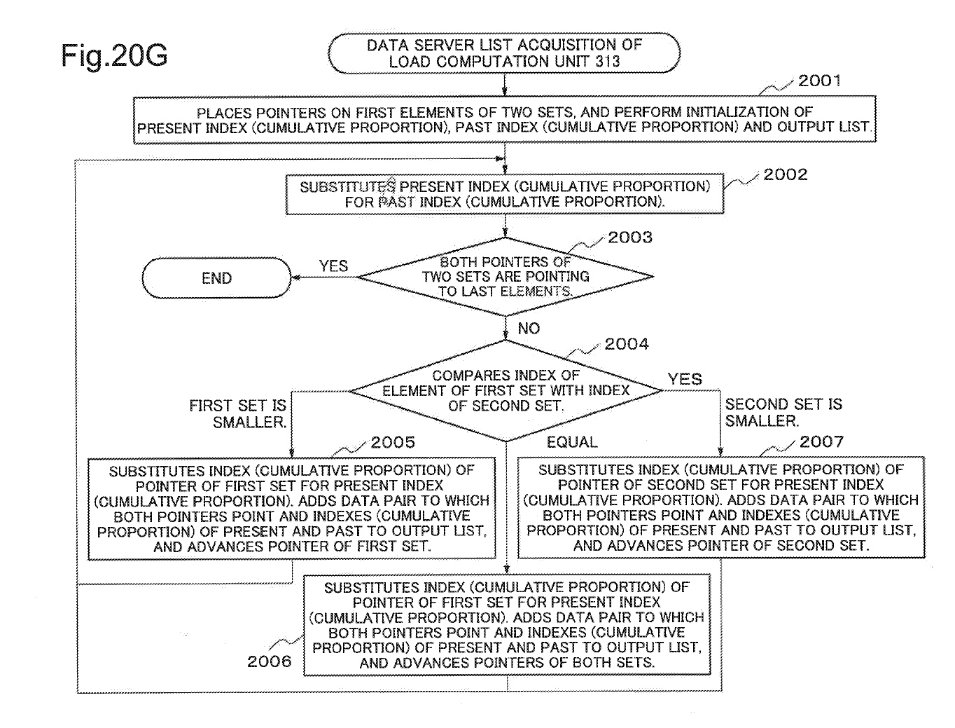

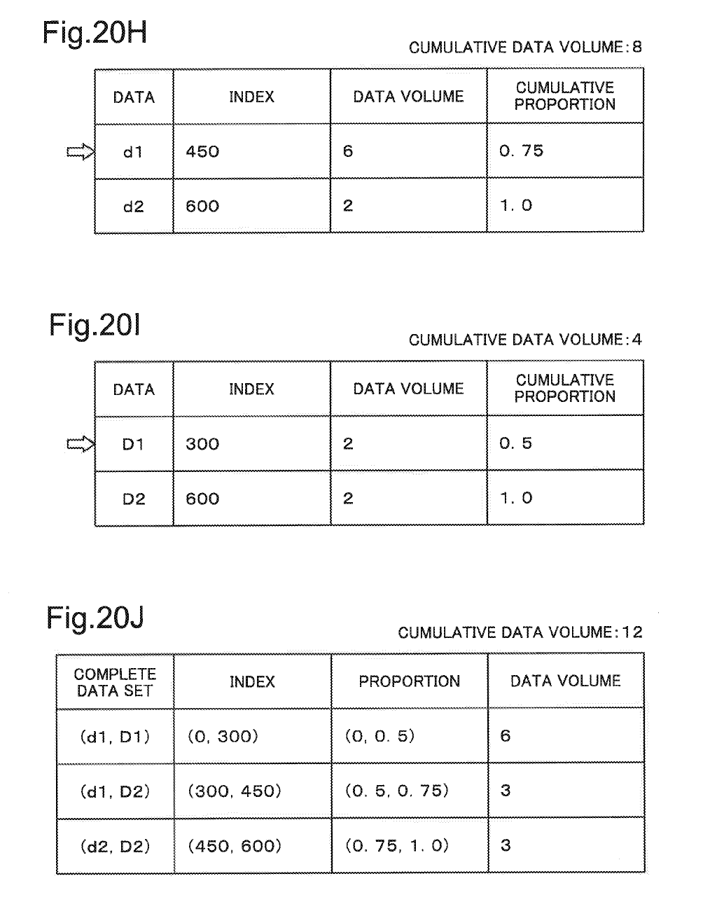

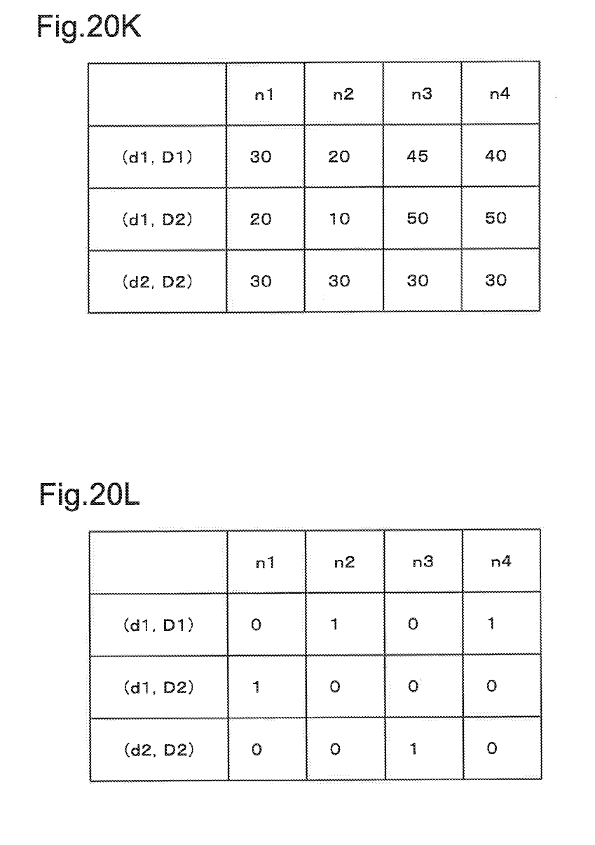

FIG. 20A indicates information which the data location storing unit 3120 of the first example stores. That is, MyDataSet1 is stored in the local file d1 of the data server n2 and the local file d2 of the data server n5 separately. MyDataSet2 is stored in the local file D1 of the data server n2 and the local file D2 of the data server n5 separately.

Each partial data set mentioned above is neither being multiplexed nor being encoded. Also, data volume of each partial data set is identical by 2 GB.

FIG. 20B indicates a configuration of the distributed system 340 of the first example. This distributed system 340 is composed of servers n1-n6 connected by switches. The servers n1-n6 function as a processing server 320 and a data server 330 depending on the situation. In this figure, any of the servers n1-n6 functions as a client 300 and a distributed processing management server 310.

First, the distributed processing management server 310 receives a data processing request from a client 300. The load computation unit 313 of the distributed processing management server 310 enumerates the local files (d1, d2) and (D1, D2) which compose MyDataSet1 and MyDataSet2 from the data location storing unit 3120 of FIG. 20A.

This same unit enumerates {(d1,D1), (d1,D2), (d2,D1), (d2,D2)} as a set of local file pairs which store the cartesian product data set of MyDataSet1 and MyDataSet2. This same unit acquires a set of data server lists {(n2,n4), (n2,n5), (n6,n4), (n6,n5)} from the local file pair with reference to the data location storing unit 3120.

Next, this same unit refers to the server status storing unit 3110, and obtains {n1, n2, n3, n4} as a set of usable processing servers 320.

This same unit refers to an output result or the like of the inter-server load acquisition unit 318, and acquires the inter-server communications load between each processing server 320 and a data server 330 in each data server list. This same unit obtains, for example, the inter-server communications load {(5,20), (5,10), (10,20), (10,10)} between the processing server n1 and the data server 330 in each data server list.

This same unit adds the inter-server communications load for each data server list, and creates a column {25,15,30,20} corresponding to the processing server n1 in the communications load matrix C.

This same unit performs the similar processing for each processing server 320, and creates the communications load matrix C between the set of data server lists and the set of processing servers 320 mentioned above. FIG. 20C indicates the created communications load matrix C.

The processing allocation unit 314 inputs the communications load matrix C, and obtains a flow rate matrix F that minimizes formula 1 under the constraint equation of formulas 3 and 4. FIG. 20D indicates the found flow rate matrix F.

This same unit creates decision information based on the obtained flow rate matrix F, and transmits to the processing servers n1 to n4.

FIG. 20B indicates data transmission and reception according to the decision information. For example, the processing server n1 receives data d2 of the data server n6 and data D2 of the data server n5, and processes.

The user program which the distributed system 340 of the second example inputs is a user program shown in FIG. 14. This program is describing that the processing program named MyMap is to be applied to the element pair associated with one to one of two data sets of MyDataSet1 and MyDataSet2.

FIG. 20E indicates information which the data location storing unit 3120 of the second example stores. Unlike the first example, data volume of each local file is not identical. The data volume of the local file d1 is 6 GB, but 2 GB for d2, D1, D2.

FIG. 20F indicates a configuration of the distributed system 340 of the second example. This distributed system 340 is composed of servers n1-n6 connected by switchs. The servers n1-n6 function as a processing server 320 and a data server 330 depending on the situation. In This figure, any of the servers n1-n6 functions as a client 300 and the distributed processing management server 310.

First, the distributed processing management server 310 receives a data processing request from a client 300. The load computation unit 313 of the distributed processing management server 310 refers to the data location storing unit 3120, and acquires a set of data server lists for obtaining all complete data sets composed of a group of each element of MyDataSet1 and MyDataSet2.

FIG. 20G is an operation flowchart of data server list acquisition of the load computation unit 313. This processing is to replace the processing of Step 1504 of FIG. 15 when associated is designated to a structure program. FIG. 20H indicates a work table for the first data set (MyDataSet1) used by this processing. FIG. 20I indicates a work table for the second data set (MyDataSet2) used by this processing. FIG. 20J indicates an output list created by this processing. The work table and the output list are created in the work area 316 of the distributed management server 310.

Data elements of indexes 1 to 450 are stored in data d1 of the first data set MyDataSet1, and data elements of indexes 451-600 are stored in data d2. An index is, for example, a sequence of data element in the data set.

The load computation unit 313 stores the last index of each subset of the first data set in the work table of FIG. 20H prior to this processing. This same unit may compute 8 GB as the data volume of this data set from the data volume of data d1 and d2, and store the cumulative proportion having accumulated the proportion to the whole in the work table of FIG. 20H.

Data elements of indexes 1 to 300 are stored in data D1 of the second data set MyDataSet2 and data elements of indexes 301-600 are stored in data D2.

This same unit stores the last index of each partial data set of the second data set in the work table of FIG. 20I prior to this processing. This same unit may compute 4 GB as the data volume of this data set from the data volume of data D1 and D2, and store the cumulative proportion having accumulated the proportion to the whole in the work table of FIG. 20I.

The load computation unit 313 performs initialization of pointers of two data sets so as to indicate the first row of each work table, initialization of indexes of present and past to 0, and initialization of output list with null (Step 2001). Next Steps 2002 and 2503 have no meaning in the first execution.

This same unit compares the index of the first data set with the index of the second data set indicated by two pointers (Step 2004).

As the second data index is smaller between the index 450 of the first data set and the index 300 of the second data set, this same unit substitutes the index 300 for the present index. This same unit composes a group of data elements in a range indicated by the indexes of past and present (0, 300), and stores this information in the fields of index and proportion of the first row (FIG. 20J) of the output list (Step 2007).

The value stored in the output list as data volume of this group is the data volume that is actually obtained by creating in this group. This value may be a value which is roughly estimated by the range of cumulative proportion which is processed in a similar way of index and the cumulative data volume which is the sum of two data sets.

Next, this same unit advances the pointer in the second work table, makes the index of the second data set 600 (Step 2007), and substitutes the present index 300 for the index in the past (Step 2002).

This same unit compares the index of the first data set and the index of the second data set in the second time (Step 2004). In this time, as the first data index is smaller between the index 450 of the first data set and the index 600 of the second data set, this same unit substitutes the index 450 of the pointer for the present index. This same unit composes a group of data elements in a range indicated by the indexes of past and present (300, 450), and stores this information in the second row (FIG. 20J) of the output list (Step 2005).

Similarly, composing the last data element group, and storing this information in the third row (FIG. 20J) of the output list (Step 2006), and after this, as the pointers of two data sets are indicating the last elements 600 (Yes in Step 2003), ending the processing. In the end of the processing, this same unit appends a local file pair ((d1, D1 or the like) corresponding to each range of indexes of the output list to the output list.

The load computation unit 313 acquires server pairs storing a local file, that is, a set of data server lists {(n2, n4), (n2, n5), (n6, n5)}, from local file pairs of the output list of FIG. 20J.

Next, this same unit acquires {n1, n2, n3, n4} as a set of usable processing servers 320 from the server status storing unit 3110.

This same unit refers to an output result or the like of the inter-server load acquisition unit 318, and acquires the inter-server communications load between each processing server 320 and a data server 330 in each data list. For example, this same unit acquires the inter-server communications load {(5, 20), (5, 10), (10, 10)} between the processing server n1 and the data server 330 in each data server list.

This same unit normalizes the inter-server communications load by the number of data elements for each data server list, performs weighted addition by data volume of the data set, and creates the row {30, 20, 30} corresponding to the processing server n1 in the communications load matrix C. In the weighted addition, the inter-server communications load with the data server 330 storing partial data set of MyDataSet1 (8 GB) is given a weight of two times of weight for the inter-server communications load with the data server 330 storing partial data set of MyDataSet2 (4 GB).

This same unit performs the similar processing for each processing server 320, and creates the communications load matrix C between the set of data server lists and the set of processing serves 320 mentioned above. FIG. 20K indicates the created communications load matrix C.

The processing allocation unit 314 inputs the communications load matrix C, and obtains a flow rate matrix F that minimizes the objective function of formula 1 under the constraints of formulas 7 and 8. FIG. 20L indicates the found flow rate matrix F.

This same unit creates decision information based on the obtained flow rate matrix F, and transmits to the processing servers n1 to n4.

FIG. 20F indicates data transmission and reception according to the decision information. For example, the processing server n1 receives data d1 (2 GB portion) of the data server n2 and data D2 (1 GB portion) of the data server n5, and processes.

### Specific Example of Fourth Exemplary Embodiment

In this specific example, the partial data sets of a processing object data set are encoded by Erasure code or the like. Also, the distributed processing management server 310 of this specific example requests a processing server 320, depending on a priority, so that it may stop other processing being executed, and execute the data processing which a client 300 requests.

The server status storing unit 3110 provided in the distributed processing management server 310 of this exemplary embodiment can store a priority that is not illustrated in the configuration information 3113 on each processing server 320 in addition to the information shown in FIG. 18B. The priority is a priority of the other processing being executed in a processing server 320.

The program shown in FIG. 19A is a user program inputted to a client 300 of this specific example. However, this user program additionally includes the designation of priority=4 other than the server usage amount=4 in the Set_config phrase. The priority designation designates that the processing requested by this user program should be executed even if a processing server 320 is executing other processing when the priority of this server is 4 or less.

The program of FIG. 19A is describing that the MyMap processing program is to be applied to the data elements included in the data set MyDataSet.

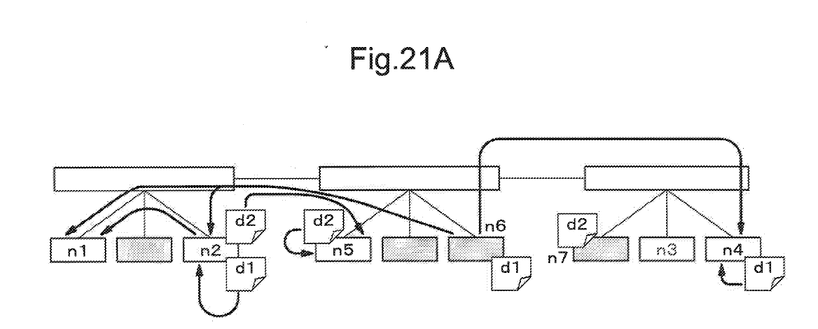

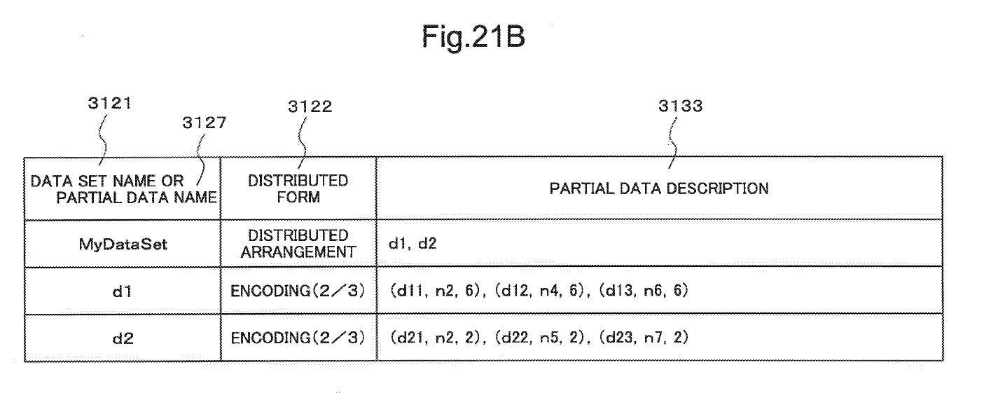

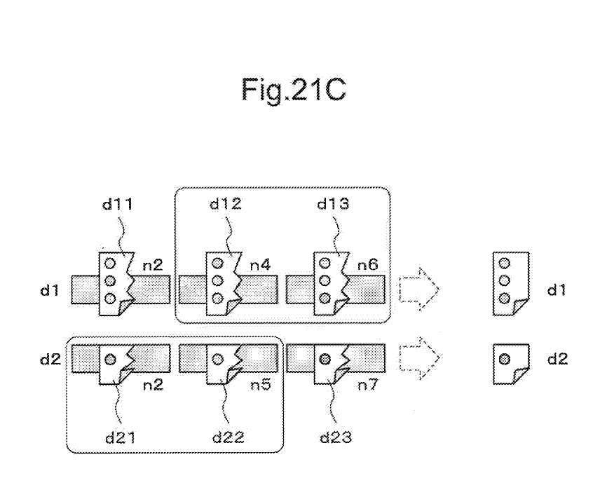

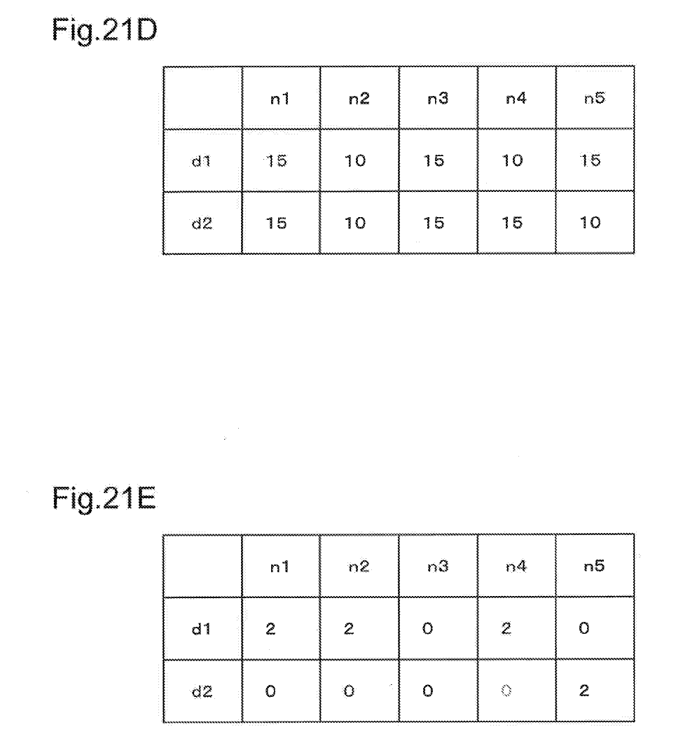

FIG. 21A indicates a configuration of the distributed system 340 of this specific example. This distributed system 340 is composed of servers n1-n6 connected by switches. The servers n1-n6 function as a processing server 320 and a data server 330 depending on the situation. In this figure, any of the servers n1-n6 functions as a client 300 and a distributed processing management server 310.

The server status storing unit 3110 of this specific example stores priority=3 in the configuration information 3113 of the processing server n5 and stores priority=3 in the configuration information 3113 of the processing server n6 in addition to the information shown in FIG. 18B.

FIG. 21B indicates information stored in the data location storing unit 3120 of this specific example. This information is showing that MyDataSet is stored by being divided into partial data sets named d1, d2, and each partial data set is encoded or is made Quorum by the number of redundancy 3, the minimum acquisition number 2. This information is describing that d1 is stored with encoded 6 GB each in the data servers n2, n4, n6, and d2 is stored with encoded 2 GB each in the data servers n2, n5, n7.

The processing server 320 can restore the partial data set d1, for example, if it acquires the data chunk d12 on the data server n4 and the data chunk d13 on the data server n6. FIG. 21C indicates a restoration example of this encoded partial data set.

The client 300 inputs the program of FIG. 19A, and transmits a data processing request including designation of server usage amount=4 and priority=4 to the distributed processing management server 310.

The load computation unit 313 of the distributed processing management server 310 refers to the data location storing unit 3120, and enumerates (d1, d2) as the partial data sets of the data set MyDataSet, and acquires a set of data server lists {(n2,n4,n6), (n2,n5,n7)}. At the same time, this same unit acquires that each partial data set is being stored with the minimum acquisition number 2.

Next, this same unit selects, from the server status storing unit 3110, the processing servers n1-n4, which can be used by a reason for such as the CPU usage rate being lower than a threshold value, and the processing server n6, which is executing other processing whose priority is lower than 4, and obtains a set of usable processing servers 320.

This same unit obtains the inter-server communications load between each processing server 320 obtained by the above and each data server 330 in each data server list. For example, this same unit obtains the inter-server communications load {(5, 20, 10), (5, 20, 10)} between the processing server n1 and each data server 330. Because the minimum acquisition number is 2, this same unit takes the summation of values up to the second from smaller with respect to a group of the communications load corresponding to d1 and d2, and obtains the complete data unit quantity acquisition load {15, 15}. At this time, this same unit also records an identifier of the corresponding processing server 320 and obtains {(n2, n6), (n2, n5)} for n1.

FIG. 21D indicates the communications load matrix C obtained in this way. This same unit excludes, based on the processing condition of server usage amount=4, the processing server n3 whoes complete data unit quantity acquisition load is large.

The processing allocation unit 314 obtains a flow rate matrix F that minimizes the objective function of formula 1 under the constraints of formulas 7 and 8. FIG. 21E indicates the flow rate matrix F obtained in this way.

This same unit creates decision information based on the obtained flow rate matrix F, and transmits to the processing servers n1, n2, n4 and n5.

FIG. 21A indicates data transmission and reception according to the decision information. For example, in order to acquire 2 GB of the partial data set d1, the processing server n1 acquires data of 2 GB portion each from the data servers n2 and n6, and decodes these and processes.

### Specific Example of Fifth Exemplary Embodiment

There are two cases in a specific example of this exemplary embodiment, one is a case that each processing server 320 has an inevitable processing load and the other case is that it does not have. The communications load of the first example is delay presumed from a configuration, and the objective function is reduction in the whole loads. The communications load of the second example is the minium bandwidth obtained by measurement, and the objective function is communications load reduction in a processing server 320 with the maximum load.

The user program inputted in the first example and the second example is shown in FIG. 4. The distributed processing management server 310 of this specific example determines which of the plurality of processing servers 320 for MyReduce processing becomes a destination for transmitting the data set which is outputted by MyMap processing and distributed arranged in a plurality of data servers 330.

Further, a data server 330 in this specific example is often a processing server 320 of MyMap processing.

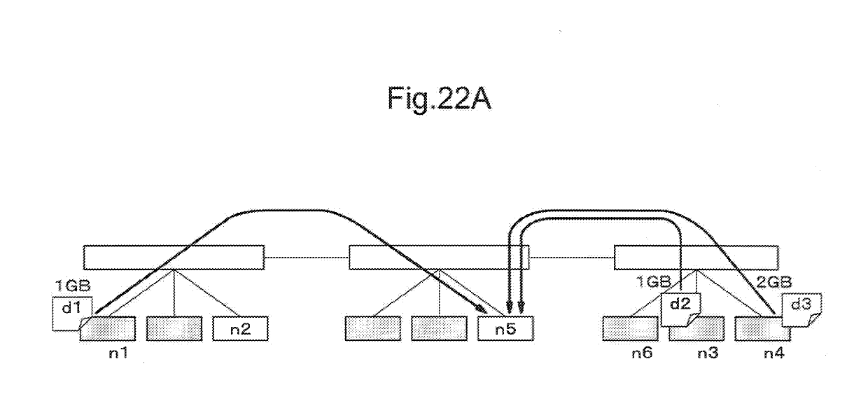

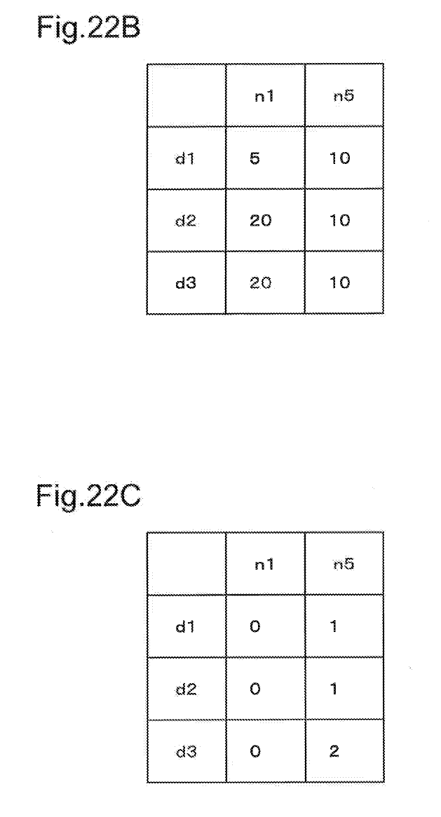

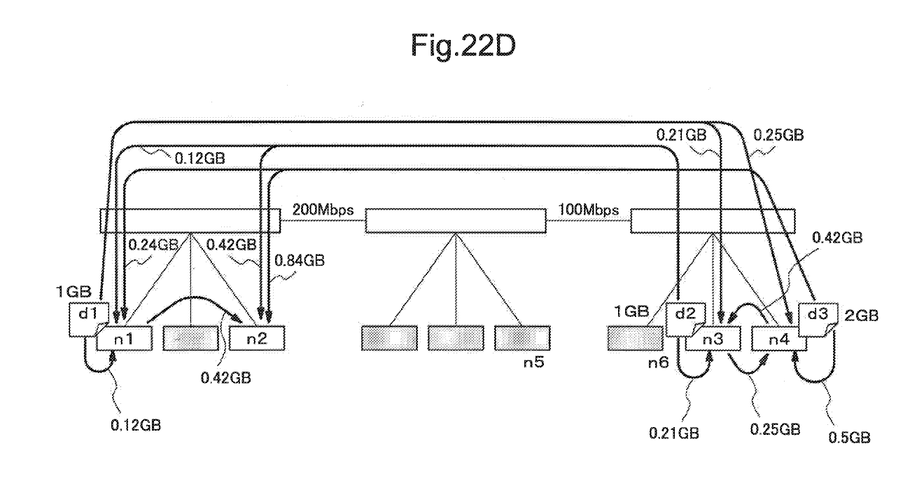

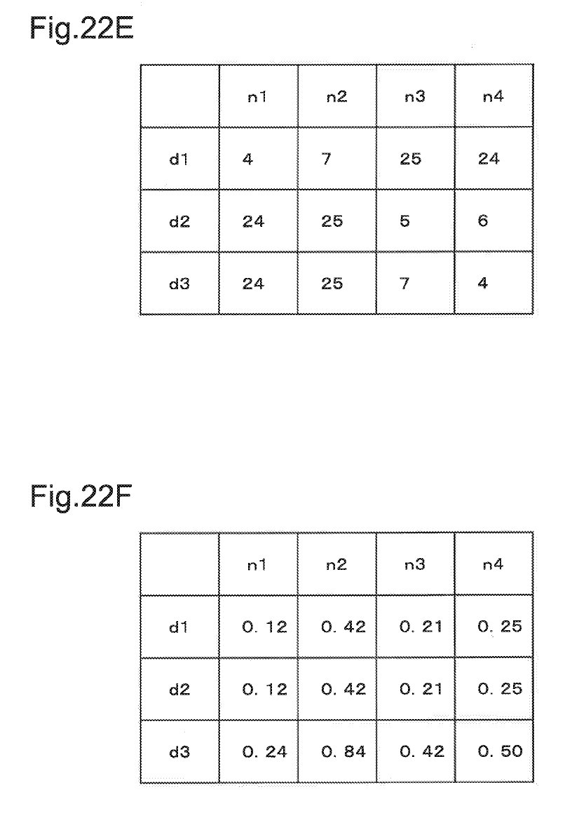

The system configuration of this specific example is shown in FIG. 22A. The servers n1, n3, n4 of the distributed system 340 shown in this figure are executing MyMap processing, and are creating output data sets d1, d2, d3. In this specific example, the servers n1, n3, n4 become a data servers 330. In this specific example, the data volume of the distributed data stored in the data servers n1, n3, n4 is an estimate value outputted by such as MyMap processing process. The servers n1, n3, n4 which are executing MyMap processing compute the estimate value as 1 GB, 1 GB, 2 GB based on the assumption that the expected value of an input/output data volume ratio is 1/4, and transmit to the distributed processing management server 310. The distributed processing management server 310 stores this estimate value in the data location storing unit 3120.

In the first example, at starting of MyReduce processing execution, the load computation unit 313 refers to the data location storing unit 3120, and enumerates a set of data servers 330 {n1,n3,n4}. This same unit refers to the server status storing unit 3110, and enumerates {n2,n5} as a set of processing servers 320.

This same unit creates a communications load matrix C based on the inter-server communications load between elements of each of the sets. FIG. 22B indicates the created communications load matrix C.

The processing allocation unit 314 minimizes the objective function of formula 14 under the constraint of formula 13 based on this communications load matrix C, obtains wj (j=n2, n5) and creates a flow rate matrix F. FIG. 22C indicates the created flow rate matrix F.

Based on this, the processing allocation unit 314 transmits to the processing server n5 decision information which instructs to acquire respective 1 GB, 1 GB, 2 GB of data d1, d2, d3 of the data servers n1, n3, n4, and to process.

Further, the processing allocation unit 314 may instruct the data servers n1, n3, n4 to transmit the output data to the processing server n5.

Also in the second example, at starting of MyReduce processing execution, the load computation unit 313 refers to the data location storing unit 3120, and enumerates a set of data servers 330 {n1,n3,n4}.

This same unit refers to the server status storing unit 3110, and acquires a set of processing servers 320 {n1, n2, n3, n4}. Further, this same unit acquires the processing capability ratio 5:4:4:5 of the processing servers 320, and the inevitable load value (25, 0, 25, 25) such as MyMap processing execution.

FIG. 22D indicates the inter-server band which the inter-server load acquisition unit 318 or the like has measured. The load computation unit 313 computes C′ij=1/minium bandwidth between route ij+20/processing capability of server j from formula 11 using this band value, and creates a communications load matrix C. FIG. 22E indicates the created communications load matrix C.

The processing allocation unit 314 minimizes the objective function of formula 17 under the constraint of formula 13 based on this communications load matrix C, and obtains wj (0.12, 0.42, 0.21, 0.25). This same unit creates a flow rate matrix F from this wj and data volume of the distributed data i (1, 1, 2). FIG. 22F indicates the created flow rate matrix F.

Based on this, the processing allocation unit 314 instructs the processing servers n1-n4 about data acquisition and processing. Or, the processing allocation unit 314 may instruct the data servers n1, n3, n4 to transmit data to the processing servers n1-n4.

For example, it is supposed that a processing object data set of MyMap processing is Web pages, MyMap processing outputs the number of words included in each page, and MyReduce processing adds the number for each of the words throughout the whole Web pages. The servers n1, n3, n4 which execute MyMap processing receive decision information based on the above-mentioned flow rate matrix F, and compute a hash value of the word between 0-1 and perform the following distributed transmission. 1) When the hash value is 0-0.12, the count value of this word is transmitted to the server n1. 2) When the hash value is 0.12-0.54, the count value of this word is transmitted to the server n2. 3) When the hash value is 0.54-0.75, the count value of this word is transmitted to the server n3. 4) When the hash value is 0.75-1.0, the count value of this word is transmitted to the server n4.

In the description of each exemplary embodiment mentioned above, the distributed processing management server 310 has realized appropriate communication when transmitting data to a plurality of processing servers 320 from a plurality of data servers 330. However, the present invention can be used also for realizing appropriate communication when a plurality of processing servers 320 which creat data transmit to a plurality of data servers 330 which receive the data and store. This is because the communications load between two servers does not change whichever transmits or receives.

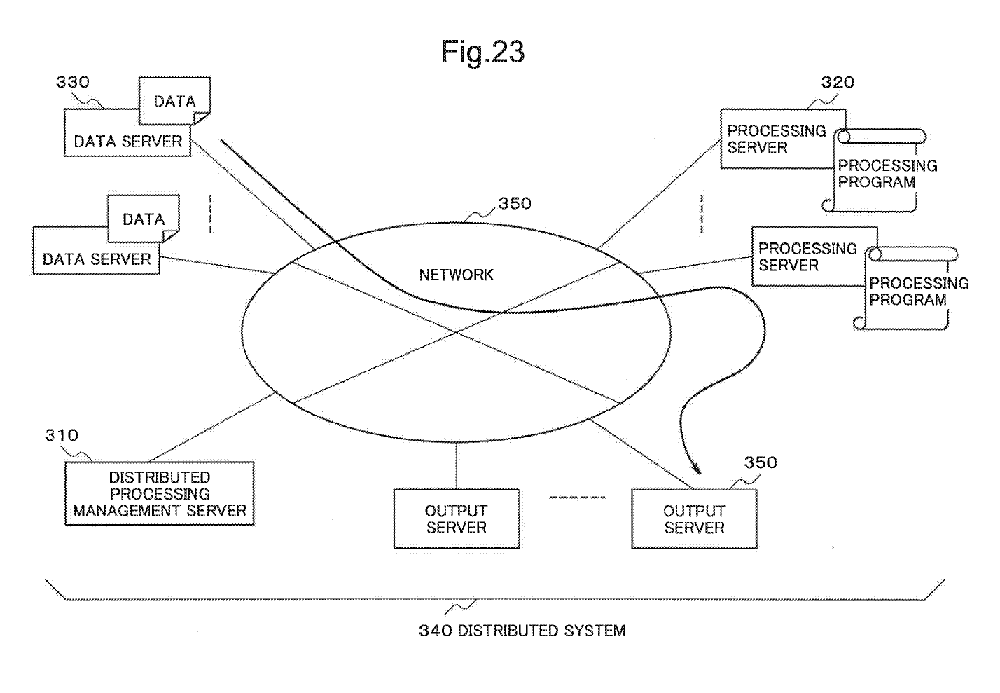

Further, the present invention can be used also for realizing appropriate communication in a mixed case of transmission and reception. FIG. 23 indicates the distributed system 340 including a plurality of output servers 350 in addition to the distributed processing management server 310, a plurality of data servers 330 and a plurality of processing servers 320. In this system, each data element of the data server 330 is processed by one of processing servers 320 of a plurality of processing servers 320 and stored in one of output servers 350 which is determined for each data element in advance.

By selecting an appropriate processing server 320 which processes each data element, the distributed processing management server 310 of this system can realize appropriate communication of the processing server 320 which includes both of reception from a data server 330 and transmission to an output server 350.

By applying communication between a processing server 320 and an output server 350 as communication in an opposite direction, this system can use the distributed processing management server 310 of the second example of the third exemplary embodiment which acquires each of two data elements associated with each of two data servers 330.

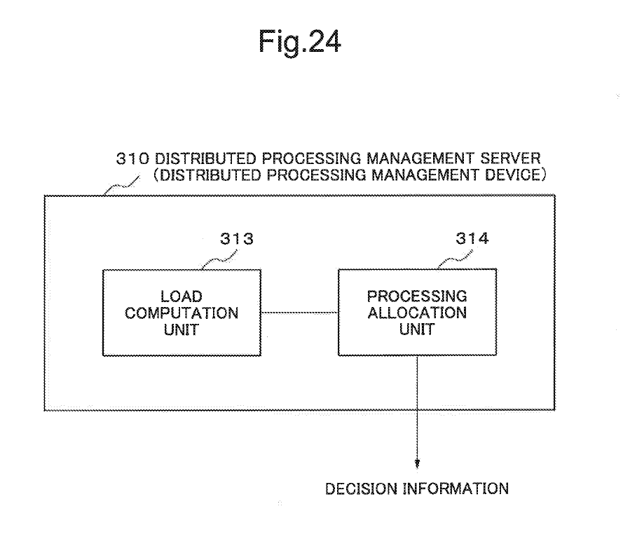

FIG. 24 indicates the exemplary embodiment of a basic structure. The distributed processing management server 310 includes a load computation unit 313 and a processing allocation unit 314.

The load computation unit 313 acquires an identifier j of a processing server 320 and a list i of a data server 330 which stores, for each complete data set i, data belonging to the complete data set. Based on a communications load for each unit data volume between the acquired each processing server 320 and each data server 330, this same unit computes c′ij including the communications load cij which each processing server 320 receives unit data volume of each complete data set.

The processing allocation unit 314 determines a nonnegative amount communication volume fij of which each processing server 320 receives each complete data set so that the prescribed sum of value including fijc′ij may become minimum.

The effect of the distributed system 340 of this exemplary embodiment is that it can realize data transmission and reception between the appropriate servers as the whole when a plurality of data servers 330 and a plurality of processing servers 320 are given.

The reason is because the distributed processing management server 310 determines a data server 330 and a processing server 320 for performing transmission and reception among whole arbitrary combinations of each data server 330 and each processing server 320. In other words, it is because that the distributed processing management server 310 does not determine data transmission and reception between servers successively forcusing on individual data server 330 and processing server 320.

While the invention has been particularly shown and described with reference to exemplary embodiments (and examples) thereof, the invention is not limited to these exemplary embodiments (and examples). It will be understood by those of ordinary skill in the art that various changes in form and details may be made therein without departing from the spirit and scope of the present invention as defined by the claims.

This application is based upon and claims the benefit of priority from Japanese patent application No. 2009-287080, filed on Dec. 18, 2009, the disclosure of which is incorporated herein in its entirety by reference.

What is claimed is:

1.-28. (canceled)

29. A distributed processing management device, which is connected with N-unit (N is a plural) of data devices belonging to M-set (M is one or more) of data device groups each of which includes one or more of the data devices and stores a subset of a set of complete data, which is a group of data elements each belonging to each of one or more prescribed data sets, and J-unit (J is a plural) of processing devices which acquire the complete data from one of the data device groups, comprising:
a load computation unit which, for each combination of the processing device and the data device group, acquires each inter-device communications load which is a communications load which occurs when the processing device receives data of unit data volume from each data device in the data device group, and computes a complete data unit quantity acquisition load c which is the communications load which occurs when the processing device receives data from one or more the data devices belonging to the data device group in order to obtain the complete data of the unit data volume; and
a processing allocation unit which determines, for each combination of the processing device and the data device group, a nonnegative amount of the communication volume f of which the processing device receives data from the one or more data devices of the data device group so that a prescribed sum of the product of the communication volume f and the complete data unit quantity acquisition load c becomes minimum, and outputs combination information of the processing device and the data device which are performing communication based on the determined communication volume f.

30. The distributed processing management device according to claim 29, wherein n-unit (n is a plural) of the data devices in the data device group store each data element belonging to the corresponding subset with redundancy or encoding, and the processing device receives data from, among the n-unit of the data devices belonging to the data device group, any of k-unit (k is an integer larger than one smaller than the n), and, based on the received k pieces of data, obtains the complete data; and
wherein the load computation unit, for each combination of the processing device and the data device group, adds smallest k pieces from the acquired n pieces of the inter-device communications load, and obtains the complete data unit quantity acquisition load c.

31. The distributed processing management device according to claim 29, wherein the data device group includes n-unit (n is a plural) of the data devices each of which stores the subset of each of the n-set of the data sets each divided into the M sets, and the processing device acquires the complete data by receiving the data element from each of the n-unit of the data devices belonging to the data device group, and
wherein the load computation unit, for each combination of the processing device and the data device group, adds all results of multiplying each inter-device communications load of the n-unit of the data devices in the data device group and a coefficient which is proportional to a size of the data element stored in the data device, and obtains the complete data unit quantity acquisition load c.

32. The distributed processing management device according to claim 29, wherein the data device group includes one data device which stores the subset of one data set divided into the M sets, and the processing device acquires the complete data by receiving the data element from the one data device belonging to the data device group, and
wherein the load computation unit, for each combination of the processing device and the data device group, makes the acquired one inter-device communications load the complete data unit quantity acquisition load c.

33. The distributed processing management device according to claim 29,
wherein the load computation unit, for each combination of the processing device and the data device group, adds the complete data unit quantity acquisition load c and a value which is proportional to a reciprocal of processing capability of the processing device, to obtain a complete data unit quantity processing load c′, and
wherein the processing allocation unit, for each combination of the processing device and the data device group, determines the communication volume f so that a summation of the product of the communication volume f and the complete data unit quantity processing load c′ becomes a minimum.

34. The distributed processing management device according to claim 29,
wherein the processing allocation unit, for each combination of the processing device and the data device group, computes a maximum allowance d′ which is proportional to the processing capability of the processing device, and determines the communication volume f so that the prescribed sum of the product of the communication volume f and the complete data unit quantity acquisition load c becomes a minimum under a constraint of the communication volume f being below the maximum allowance d′.

35. The distributed processing management device according to claim 29,
wherein the processing allocation unit, for each combination of the processing device and the data device group, determines the communication volume f so that the prescribed sum of the product of f and the complete data unit quantity acquisition load c becomes a minimum under a constraint that the each data device transmits data of identical proportion to the processing device.

36. The distributed processing management device according to claim 29,
wherein the processing allocation unit
obtains, for each combination of the processing device and the data device group, a sum of the product of the communication volume f and the complete data unit quantity acquisition load c as the prescribed sum, or
computes, for each of the processing devices, a sum of the product of the communication volume f and the complete data unit quantity acquisition load c and obtains the maximum value among the computed values as the prescribed sum; and
determines, for each combination of the processing device and the data device group, the communication volume f so that the prescribed sum becomes a minimum.

37. The distributed processing management device according to claim 29, wherein the processing allocation unit, for each of the processing devices, acquires a valueδ which indicates a processing load or a communications load the processing device holds in advance, and computes a sum of the δ and the product of the communication volume f and the complete data unit quantity acquisition load c, and,
for each combination of the processing device and the data device group, determines the communication volume f so that the maximum value among the computed values becomes a minimum.

38. A distributed processing management method comprising:
connecting a distributed processing management device with N-unit (N is a plural) of data devices belonging to M-set (M is one or more) of data device groups each of which includes one or more of the data devices and stores a subset of a set of complete data, which is a group of data elements each belonging to each of one or more prescribed data sets, and
J-unit (J is a plural) of processing devices which acquire the complete data from one of the data device groups;
acquiring, for each combination of the processing device and the data device group, each inter-device communications load which is a communications load which occurs when the processing device receives data of unit data volume from each data device in the data device group;
computing, a complete data unit quantity acquisition load c which is the communications load which occurs when the processing device receives data from one or more the data devices belonging to the data device group in order to obtain the complete data of the unit data volume;
determining, for each combination of the processing device and the data device group, a nonnegative amount of the communication volume f of which the processing device receives data from one or more the data devices of the data device group so that a prescribed sum of the product of the communication volume f and the complete data unit quantity acquisition load c becomes a minimum; and
outputting combination information of the processing device and the data device which are performing communication based on the determined communication volume f.

39. The distributed processing management method according to claim 38, wherein n-unit (n is a plural) of data devices in the data device group store each data element belonging to the corresponding subset with redundancy or encoding, and the processing device receives data from, among the n-unit of data devices belonging to the data device group, any of k-unit (k is an integer larger than one smaller than n), and is obtaining the complete data based on the received k pieces of data, and
the distributed processing management method comprises adding, for each combination of the processing device and the data device group, smallest k pieces from the acquired n pieces of inter-device communications loads, and obtaining the complete data unit quantity acquisition load c.

40. The distributed processing management method according to claim 38, wherein when the data device group includes n-unit (n is a plural) of the data devices each of which stores the subset of each of the n-set of data sets each divided into the M sets, and the processing device acquires the complete data by receiving the data element from each of the n-unit of the data devices belonging to the data device group, and
the distributed processing management method comprises adding, for each combination of the processing device and the data device group, all results of multiplying each inter-device communications load of the n-unit of the data devices in the data device group and a coefficient which is proportional to a size of the data element stored in the data device, and obtaining the complete data unit quantity acquisition load c.

41. The distributed processing management method according to claim 38, wherein when the data device group includes one data device which stores the subset of one data set divided into the M sets, and the processing device acquires the complete data by receiving the data element from the one data device belonging to the data device group, and
the distributed processing management method comprises outputting, for each combination of the processing device and the data device group, the acquired one inter-device communications load as the complete data unit quantity acquisition load c.

42. The distributed processing management method according to claim 38, comprising
adding, for each combination of the processing device and the data device group, the complete data unit quantity acquisition load c and a value which is proportional to a reciprocal of processing capability of the processing device, to obtain a complete data unit quantity processing load c′, and
determining, for each combination of the processing device and the data device group, the communication volume f so that a summation of the product of the communication volume f and the complete data unit quantity processing load c′ becomes a minimum.

43. The distributed processing management method according to claim 38, comprising
for each combination of the processing device and the data device group, computing a maximum allowance d′ which is proportional to the processing capability of the processing device, and determining the communication volume f so that the prescribed sum of the product of the communication volume f and the complete data unit quantity acquisition load c becomes a minimum under a constraint of the communication volume f being below the maximum allowance d′.

44. The distributed processing management method according to claim 38, comprising
for each combination of the processing device and the data device group, determining the communication volume f so that the prescribed sum of the product of the communication volume f and the complete data unit quantity acquisition load c becomes a minimum under a constraint that the each data device transmits data of identical proportion to the processing device.

45. The distributed processing management method according to claim 38, comprising
obtaining, for each combination of the processing device and the data device group, a sum of the product of the communication volume f and the complete data unit quantity acquisition load c as the prescribed sum, or
computing, for each of the processing devices, a sum of the product of the communication volume f and the complete data unit quantity acquisition load c and obtaining the maximum value among the computed values as the prescribed sum; and
determining, for each combination of the processing device and the data device group, the communication volume f so that the prescribed sum becomes a minimum.

46. The distributed processing management method according to claim 38,
for each of the processing devices, acquiring a valueδ which indicates a processing load or a communications load the processing device holds in advance, and computing a sum of the δ and the product of the communication volume f and the complete data unit quantity acquisition load c, and
for each combination of the processing device and the data device group, determining the communication volume f so that the maximum value among the computed values becomes a minimum.

47. A non-transient computer readable recording medium having embodied thereon a distributed processing management program, which when executed by a computer which is connected with N-unit (N is a plural) of data devices belonging to M-set (M is one or more) of data device groups each of which includes one or more of the data devices and stores a subset of a set of complete data, which is a group of data elements each belonging to each of one or more prescribed data sets, and J-unit (J is a plural) of processing devices which acquire the complete data from one of the data device groups, causes the computer to process the following processing of:
load computation processing for acquiring, for each combination of the processing device and the data device group, each inter-device communications load which is a communications load which occurs when the processing device receives data of unit data volume from each data device in the data device group, and computing a complete data unit quantity acquisition load c which is the communications load which occurs when the processing device receives data from the data device belonging to the data device group in order to obtain the complete data of the unit data volume; and
processing allocation processing for determining, for each combination of the processing device and the data device group, a nonnegative amount of the communication volume f of which the processing device receives data from the one or more data devices of the data device group so that a prescribed sum of the product of the communication volume f and the complete data unit quantity acquisition load c becomes a minimum, and outputting combination information of the processing device and the data device which are performing communication based on the determined communication volume f.

48. The non-transient computer readable recording medium having embodied thereon the distributed processing management program according to claim 47, wherein n-unit (n is a plural) of data devices in the data device group store each data element belonging to the corresponding subset with redundancy or encoding, and the processing device receives data from, among the n-unit of data devices belonging to the data device group, any of k-unit (k is an integer larger than one smaller than the n), and is obtaining the complete data,
the load computation processing causes the computer to process the processing of adding, for each combination of the processing device and the data device group, smallest k pieces from the acquired n pieces of the inter-device communications load, and obtaining the complete data unit quantity acquisition load c.

49. The non-transient computer readable recording medium having embodied thereon the distributed processing management program according to claim 47, wherein when the data device group includes n-unit (n is a plural) of the data devices each of which stores the subset of each of the n-set of the data sets each divided into the M sets, and the processing device acquires the complete data by receiving the data element from each of n-unit of the data devices belonging to the data device group,
the load computation processing causes the computer to process the processing of adding, for each combination of the processing device and the data device group, all results of multiplying each inter-device communications load of the n-unit of the data devices in the data device group and a coefficient which is proportional to a size of the data element stored in the data device, and obtaining the complete data unit quantity acquisition load c.

50. The non-transient computer readable recording medium having embodied thereon the distributed processing management program according to claim 47, wherein when the data device group includes one data device which stores the subset of one data set divided into the M sets, and the processing device the complete data by receiving the data element from the one data device belonging to the data device group,
the load computation processing causes the computer to process the processing of outputting, for each combination of the processing device and the data device group, the acquired one inter-device communications load as the complete data unit quantity acquisition load c.

51. The non-transient computer readable recording medium having embodied thereon the distributed processing management program according to any one of claims 47,
wherein the load computation processing causes the computer to process the processing of adding, for each combination of the processing device and the data device group, the complete data unit quantity acquisition load c and a value which is proportional to a reciprocal of processing capability of the processing device, and computing a complete data unit quantity processing load c′, and
wherein the processing allocation processing causes the computer to process the processing of determining, for each combination of the processing device and the data device group, the communication volume f so that a sum of the product of the communication volume f and the complete data unit quantity processing load c′ becomes a minimum.

52. The non-transient computer readable recording medium having embodied thereon the distributed processing management program according to any one of claims 47,
wherein the processing allocation processing causes the computer to process the processing of computing, for each combination of the processing device and the data device group, a maximum allowance d′ which is proportional to the processing capability of the processing device, and determining the communication volume f so that the prescribed sum of the product of the communication volume f and the complete data unit quantity acquisition load c becomes a minimum under a constraint of the communication volume f being below the maximum allowance d′.

53. The non-transient computer readable recording medium having embodied thereon the distributed processing management program according to any one of claims 47,
wherein the processing allocation processing causes the computer to process the processing of determining, for each combination of the processing device and the data device group, the communication volume f so that the prescribed sum of the product of the communication volume f and the complete data unit quantity acquisition load c becomes a minimum under a constraint that the each data device transmits data of identical proportion to the processing device.

54. The non-transient computer readable recording medium having embodied thereon the distributed processing management program according to any one of claims 47,
wherein the processing allocation processing causes the computer to process the processing of:
obtaining, for each combination of the processing device and the data device group, a sum of the product of the communication volume f and the complete data unit quantity acquisition load c as the prescribed sum, or
computing, for each of the processing devices, a sum of the product of the communication volume f and the complete data unit quantity acquisition load c and obtaining the maximum value among the computed values as the prescribed sum; and
determining, for each combination of the processing device and the data device group, the communication volume f so that the prescribed sum becomes a minimum.

55. The non-transient computer readable recording medium having embodied thereon the distributed processing management program according to any one of claims 47,
wherein the processing allocation processing causes the computer to process the processing of:
for each of the processing devices, acquiring a valueδ which indicates a processing load or a communications load the processing device holds in advance, and computing a sum of δ and the product of the communication volume f and the complete data unit quantity acquisition load c, and
for each combination of the processing device and the data device group, determining the communication volume f so that the maximum value among the computed values becomes a minimum.

56. A distributed processing management device, which is connected with
N-unit (N is a plural) of data devices belonging to M-set (M is one or more) of data device groups each of which includes one or more of the data devices and stores a subset of a set of complete data, which is a group of data elements each belonging to each of one or more prescribed data sets, and
J-unit (J is a plural) of processing devices which acquire the complete data from one of the data device groups, comprising:
a load computation means for, for each combination of the processing device and the data device group,
acquiring each inter-device communications load which is a communications load which occurs when the processing device receives data of unit data volume from each data device in the data device group, and
computing a complete data unit quantity acquisition load c which is the communications load which occurs when the processing device receives data from one or more the data devices belonging to the data device group in order to obtain the complete data of the unit data volume; and
a processing allocation means for, determining, for each combination of the processing device and the data device group, a nonnegative amount of the communication volume f of which the processing device receives data from the one or more data devices of the data device group so that a prescribed sum of the product of the communication volume f and the complete data unit quantity acquisition load c becomes a minimum, and outputting combination information of the processing device and the data device which are performing communication based on the determined communication volume f.
